(19) United States
(12) Patent Application Publication
(10) Pub. No.: US 2020/0298415 A1
(43) Pub. Date: Sep. 24, 2020

(54) AUTONOMOUS CLEANING ROBOT

(71) Applicants: ANKOBOT (SHENZHEN) SMART TECHNOLOGIES CO., LTD., Shenzhen (CN); ANKOBOT (SHANGHAI) SMART TECHNOLOGIES CO., LTD., Shanghai (CN)

(72) Inventors: Jiajian SUN, Shenzhen (CN); Shengli GAO, Shenzhen (CN)

(21) Appl. No.: 16/521,719

(22) Filed: Jul. 25, 2019

Related U.S. Application Data
(63) Continuation of application No. PCT/CN2019/082576, filed on Apr. 12, 2019.

(30) Foreign Application Priority Data
Mar. 18, 2019 (CN) 201910204626.7

(51) Int. Cl. B25J 11/00; A47L 11/24; A47L 11/40; A47L 11/20; A47L 9/28

(52) U.S. Cl. CPC B25J 11/0085; A47L 11/24; A47L 11/4011; A47L 2201/06; A47L 11/20; A47L 11/4052; A47L 9/2826; A47L 11/4069

(57) ABSTRACT

The present application provides an autonomous cleaning robot, the robot comprises: a robot body, comprising an assembly section and a suction port; a drive system, comprising drive wheels, the drive wheels being disposed on opposite sides of the robot body and configured to drive the robot body to move; a control system, disposed on the robot body and configured to control the drive wheels; a dust suction assembly disposed in the assembly section, an air inlet channel of the dust suction assembly being communicated with the suction port, and the dust suction assembly being used to suck dust under a negative pressure; and a variable dust collection channel disposed at peripheral of the suction port, the variable dust collection channel being used for sweeping and scraping to collect dust in a first state and used for forming a dust suction channel communicated with the suction port in a second state.

### RELATED APPLICATION

This application is a continuation application of International Patent Application No. PCT/CN2019/082576, filed Apr. 12, 2019, which claims priority to Chinese Patent Application No. 2019102046267, filed Mar. 18, 2019, the entire contents of which are hereby incorporated by reference.

### TECHNICAL FIELD

The present application relates to the field of mobile robots, and in particular relates to an autonomous cleaning robot.

### BACKGROUND OF THE INVENTION

With the development of science and technology and the improvement of living standards, cleaning robots have been widely used. A cleaning robot, also known as automatic sweeping machine, intelligent vacuum cleaner, autonomous cleaning robot or the like, is a type of intelligent household appliances that can perform operations such as cleaning, dust collection, and floor mopping. The cleaning robot can be controlled by a person (for example, an operator controls the robot by a remote control) or autonomously perform ground cleaning operation in the room according to certain preset rules, and it can clear away rubbish such as hair, dust and debris on the floor surface.

For cleaning robots, the dust suction ability is an important performance thereof, and brushes play a very important role in the dust suction ability of existing cleaning robots. The brushes generally include a side brush (also known as lateral brush, auxiliary brush, etc.) disposed on at least one side of the bottom of the cleaning robot, and a roller brush (also known as cleaning roller, main cleaning brush, etc.) disposed near the center of the bottom of the cleaning robot. The side brush can extend beyond the front side of a body of the cleaning robot, and can be used to agitate debris around corners and furniture for example. The cleaning robot accumulates rubbish such as hair, dust and debris on the center of a travelling route of the cleaning robot through rotation of the side brush, and then agitates the rubbish on the ground through rotation of the roller brush, so that the vacuum sucks the rubbish into a suction port by means of suction force, thereby performing cleaning, dust suction and collection operations. Generally, the vacuum includes a fan assembly, configured to generate a negative pressure and a positive pressure.

To improve the dust suction ability, the cleaning robot at present is usually provided with both side brush and roller brush, which is complex in structure. Due to partially extending beyond the cleaning robot body, the side brush is liable to collide with wall corners, furniture, electric wires, obstacles and the like, which is prone to abrasion. Generally, the roller brush can be provided with a bristle, scraper or the like, and during operation of the cleaning robot, the roller brush rotates so as to drive the bristle or scraper to rotate. To suck the rubbish better, the bristle or scraper needs to be contacted with the ground, which leads to abrasion thereof. In addition, when the cleaning robot moves, due to the complexity of the operating environment, the side brush or roller brush of the cleaning robot is often entangled with some flexible obstacles (such as wires, cables, ropes, ribbons, leftover of cloth, etc.), so that the mobile robot cannot move no longer, or even fall over and cause a security incident. Moreover, the roller brush is very liable to be entangled with hair, which is difficult to be removed and can further reduce its dust suction ability. And the cost is increased if the roller is replaced frequently. As the cleaning robot sucks the rubbish on the ground into the robot body mainly by means of the suction force of the vacuum, the larger the roller brush is, the more rubbish can be agitated or adsorbed, but correspondingly, the dedusting ability of the cleaning robot is weakened. Furthermore, a larger roller brush can increase the volume of the cleaning robot and reduce the design space for other structures. However, if the roller brush is small, the rubbish agitated or adsorbed at a time is too little; moreover, as the contact area between a small roller brush and the ground is also small, the rubbish is very likely to escape, thus greatly affecting the dust suction efficiency.

### SUMMARY OF THE INVENTION

In view of the above discussed shortcomings of the prior art, the present application provides an autonomous cleaning robot for solving the problems in the prior art.

To achieve the above and other related objects, the present application provides an autonomous cleaning robot, the autonomous cleaning robot comprises: a robot body, comprising an assembly section and a suction port, the suction port being disposed on the bottom of the robot body and towards a surface to be cleaned; a drive system, comprising drive wheels, the drive wheels being disposed on opposite sides of the robot body and configured to drive the robot body to move; a control system, disposed on the robot body and configured to control the drive wheels; a dust suction assembly disposed in the assembly section, an air inlet channel of the dust suction assembly being communicated with the suction port, and the dust suction assembly being used to suck dust under a negative pressure; and a variable dust collection channel disposed at peripheral of the suction port, the variable dust collection channel being used for sweeping and scraping to collect dust in a first state and used for forming a dust suction channel communicated with the suction port in a second state.

In certain embodiments of the present application, wherein the control system is further configured to control switching between the first sate and the second state of the variable dust collection channel in according to a preset time interval, or according to a power output by the dust suction assembly, or according to the traveling distance or speed of the drive wheels.

In certain embodiments of the present application, the autonomous cleaning robot further comprises a debris detection system configured to detect a debris state, the control system is further configured to control switching between the first sate and the second state of the variable dust collection channel according to the detected state of debris.

In certain embodiments of the present application, wherein the variable dust collection channel comprises: a first scraper, the first scraper is disposed at a first side of the suction port and contacts with the surface to be cleaned, the first scraper is used for sweeping and scraping to collect dust when the robot body moves; and a second scraper, the second scraper is movably disposed at a second side of the suction port, the first scraper and the second scraper form the dust suction channel communicated with the suction port when the second scraper contacts with the surface to be cleaned.

In certain embodiments of the present application, wherein a direction in which the drive system drives the robot body to advance is defined as a front direction, the first scraper is disposed at rear side of the suction port, and the second scraper is disposed at front side of the suction port.

In certain embodiments of the present application, wherein the first scraper and the second scraper are parallel to each other.

In certain embodiments of the present application, wherein the first scraper or the second scraper is made of a flexible material.

In certain embodiments of the present application, wherein the length of the dust suction channel formed by the first scraper and the second scraper is equal to the width of the robot body; or the length of the dust suction channel formed by the first scraper and the second scraper is equal to or greater than a distance between the drive wheels disposed on either side of the robot body.

In certain embodiments of the present application, wherein the first scraper or the second scraper comprises a mounting part, a connecting part, a reinforcing part and a blade part, the blade part is used for contacting with the surface to be cleaned.

In certain embodiments of the present application, wherein the dust suction channel formed by the first scraper and the second scraper is provided with one air inlet arranged on one side of the robot body, and the suction port is disposed far away from the air inlet of the dust suction channel.

In certain embodiments of the present application, wherein the dust suction channel formed by the first scraper and the second scraper is provided with two air inlets arranged on either side of the robot body, and the suction port is disposed in the middle of the dust suction channel.

In certain embodiments of the present application, wherein the second scraper is driven by a drive mechanism to go up and down, and the drive mechanism comprises: a lifting component, comprising a lifting body for fixing the second scraper, the lifting body is provided with an slot; a swing component, comprising a swing arm and a connecting rod arranged vertically on a first end of the swing arm, the connecting rod is inserted into the slot, and when the swing component swings, the connecting rod performs rectilinear motion within the slot to drive the second scraper arranged on the lifting component down to contact with the surface to be cleaned, or up to away from the surface to be cleaned; and a drive motor arranged on the robot body, an output shaft of the drive motor is coupled to a second end of the swing arm perpendicularly, and the drive motor is used to provide swing power to the swing arm when working.

In certain embodiments of the present application, wherein the second scraper is driven by a drive mechanism to go up and down, and the drive mechanism comprises: a rotating component, comprising a rotating body for fixing the second scraper and a rotating shaft provided on the rotating body; and a drive motor, an output shaft of the drive motor is coupled with a rotating shaft of the rotating component, and the drive motor is used to provide rotary power to the rotating shaft when working to drive the second scraper arranged on the rotating body to contact with the surface to be cleaned, or to away from the surface to be cleaned.

In certain embodiments of the present application, wherein the robot body is provided with at least one driven wheel, the driven wheel together with the drive wheels on both sides of the robot body keep the balance of the robot body in a moving state.

In certain embodiments of the present application, wherein the robot body is provided with a cliff sensor on at least one side.

In certain embodiments of the present application, wherein the direction in which the drive system drives the robot body to advance is defined as the front direction, and a buffering assembly is provided at the front end of the robot body.

In certain embodiments of the present application, wherein the direction in which the drive system drives the robot body to advance is defined as the front direction, and a plurality of obstacle detectors are arranged at the periphery of the front end of the robot body.

In certain embodiments of the present application, wherein the control system comprises at least one system of a positioning and navigation system, a mileage calculation system, a vision measurement system, an object recognition system, and a voice recognition system.

In certain embodiments of the present application, wherein a direction in which the drive system drives the robot body to advance is defined as the longitudinal direction, and the dust suction assembly is arranged transversely in the robot body.

In certain embodiments of the present application, wherein the suction port of the robot body is adjacent to a first drive wheel of the drive wheels on either side of the robot body, and an air outlet of the dust suction assembly is adjacent to a second drive wheel of the drive wheels on either side of the robot body.

As described above, in the autonomous cleaning robot of the present application, the variable dust collection channel is provided at peripheral of the suction port, wherein in the first state, the autonomous cleaning robot performs sweeping and scraping operation to collect rubbish on the ground, so that the rubbish such as hair, dust and debris is collected into the variable dust collection channel; and wherein in the second state, the variable dust collection channel of the autonomous cleaning robot and the communicated suction port form the dust suction channel, and the rubbish on the ground is sucked into the suction port by means of the suction force of the vacuum, and then sucked into the dust suction channel, in view of this, the autonomous cleaning robot of the present application has the first state and the second state, and performs sweeping and scraping to collect dust or dust suction through switching between the first state and the second state, so that strong dust suction ability and high cleaning efficiency can be achieved and the energy loss can be reduced.

### BRIEF DESCRIPTION OF THE DRAWINGS

FIG. 1 shows a structure diagram of an autonomous cleaning robot of the present application in an embodiment in a first form.

FIG. 2 shows a schematic diagram at a bottom view of the autonomous cleaning robot of the present application in an embodiment in the first form.

FIG. 3 shows a schematic diagram at a bottom view of the autonomous cleaning robot of the present application in an embodiment in a second form.

FIG. 4 shows a bottom view of the autonomous cleaning robot of the present application in an embodiment in the first form.

FIG. 5 shows a bottom view of the autonomous cleaning robot of the present application in an embodiment in the second form.

FIG. 6 shows a schematic diagram at a bottom view of the autonomous cleaning robot of the present application in an embodiment in the first form.

FIG. 7 shows a schematic diagram at a bottom view of the autonomous cleaning robot of the present application in an embodiment in the second form.

FIG. 8 shows a structure diagram of a scraper of the autonomous cleaning robot of the present application in an embodiment in the first or second form.

FIG. 9 shows a schematic diagram of a drive structure of the autonomous cleaning robot of the present application in an embodiment in the first or second form.

FIG. 10 shows an enlarged diagram of A in FIG. 9.

FIG. 11 shows schematically action of the drive structure in one direction of the autonomous cleaning robot of the present application in an embodiment in the second form.

FIG. 12 shows schematically action of the drive structure in another direction of the autonomous cleaning robot of the present application in an embodiment in the second form.

FIG. 13 shows a top view of the autonomous cleaning robot of the present application in an embodiment in the first form.

FIG. 14 shows a sectional view of the autonomous cleaning robot of the present application in an embodiment in the first form.

FIG. 15 shows a sectional view of the autonomous cleaning robot of the present application in an embodiment in the first form.

FIG. 16 shows an enlarged diagram of B in FIG. 15.

FIG. 17 shows a structure diagram of the autonomous cleaning robot of the present application in an on-line working mode in an embodiment in the first form.

FIG. 18 shows a structure diagram at a top view of the autonomous cleaning robot of the present application in an embodiment in the second form.

FIG. 19 shows a structure diagram at a bottom view of the autonomous cleaning robot of the present application in an embodiment in the second form.

FIG. 20 shows a side sectional view of the autonomous cleaning robot of the present application in an embodiment in the second form.

### DETAILED DESCRIPTION

Implementations of the present application will be described below through specific embodiments, and those skilled in the art can easily understand other advantages and effects of the present application from the contents disclosed in the present specification.

In the following description, several embodiments of this application are described combined with the drawings. However, it should be understood that other embodiments may be available, and any changes in mechanical composition, structure, electrical and operation may be made without departing from the spirit and scope of the application. The following detailed description is not to be considered as limited, and the scope of the embodiments of the present invention is defined by the appended claims. The terminology used herein is only for describing particular embodiments, spatial-related terms such as “up”, “down”, “left”, “right”, “below”, “top”, “above”, “bottom”, etc., may be used in the text for illustrating the relationship of one element or feature to another element or feature.

In some examples, the terms first, second and the like are used herein for describing various elements or parameters, but the elements or parameters should not be limited by the terms. The terms are only used for distinguishing one element or parameter from another element or parameter. For example, a first clamping structure may be referred to as a second clamping structure, and similarly, a second clamping structure may be referred to as a first clamping structure, without departing from the scope of the various described embodiments. The first clamping structure and the second clamping structure are each used to describe a clamping structure, but they are not the same clamping structure unless otherwise specified in the context.

Moreover, as used herein, such single forms as “one”, “a” and “the” aim at also including the plural forms, unless contrarily indicted in the text. It should be further understood that, such terms as “comprise” and “include” indicate the existence of the features, steps, operations, elements, components, items, types and/or groups, but do not exclude the existence, emergence or addition of one or more other features, steps, operations, elements, components, items, types and/or groups. The terms “or” and “and/or” used herein are explained to be inclusive, or indicate any one or any combination. Therefore, “A, B or C” or “A, B and/or C” indicates “any of the following: A; B; C; A and B; A and C; B and C; A, B and C”. Exceptions of the definition only exist when the combinations of elements, functions, steps or operations are mutually exclusive inherently in some ways.

The present application will be further described in detail below with reference to the accompanying drawings and specific embodiments.

The present application is to disclose a mobile robot, the mobile robot is a machine that automatically performs a specific job. It can be operated under the command of human operators or in pre-programmed programs, or act according to principles and guidelines formulated with artificial intelligence technology. Such mobile robots can be used indoors or outdoors, in industry or at home, can replace a security guard for an inspection tour, or replace a person for cleaning the ground, and can also be used for family companion, office assistance or the like. Taking the most common cleaning robot as an example, a cleaning robot, also known as autonomous cleaning robot, automatic sweeping machine, intelligent vacuum cleaner or the like, is a type of intelligent household appliance that can perform cleaning, dust collection, and floor mopping work. Specifically, the cleaning robot can be controlled by a person (for example, an operator controls the robot by a remote control or the robot is controlled through an APP loaded on an intelligent terminal) or autonomously performs a ground cleaning task in the room according to certain set rules, and can clear away rubbish on the ground such as hair, dust and debris.

For cleaning robots, the dust suction ability is an important performance thereof, and brushes play a very important role in the dust suction ability of existing cleaning robots. The brushes generally include a side brush (also known as lateral brush, auxiliary brush, etc.) disposed on at least one side of the bottom of the cleaning robot, and a roller brush (also known as cleaning roller, main cleaning brush, etc.) disposed near the center of the bottom of the cleaning robot. The side brush can extend beyond the side surface and the front surface of a body of the cleaning robot, and can be used to agitate debris around corners and furniture for example. The cleaning robot accumulates rubbish such as hair, dust and debris on the center of a travelling route of the cleaning robot through rotation of the side brush, and then agitates the rubbish on the ground through rotation of the roller brush, so that the vacuum sucks the rubbish into a suction port by means of suction force, thereby performing cleaning, dust suction and collection operations.

To improve the dust suction ability, the cleaning robot at present is usually provided with both side brush and roller brush, which is complex in structure. Due to partially extending beyond the cleaning robot body, the side brush is liable to collide with wall corners, furniture, obstacles and the like, which is prone to abrasion. Generally, the roller brush can be provided with a bristle, scraper or the like, and during operation of the cleaning robot, the roller brush rotates so as to drive the bristle or scraper to rotate. To suck the rubbish better, the bristle or scraper needs to be contacted with the ground, which leads to abrasion thereof. Moreover, the roller brush is very liable to be entangled with hair, which is difficult to be removed and can further reduce its dust suction ability. And the cost is increased if the roller is replaced frequently. As the cleaning robot sucks the rubbish on the ground into the robot body mainly by means of the suction force of the vacuum, the larger the roller brush is, the more rubbish can be agitated or adsorbed, but correspondingly, the dedusting ability of the cleaning robot is weakened. Furthermore, a larger roller brush can increase the volume of the cleaning robot and reduce the design space for other structures. However, if the roller brush is small, the rubbish agitated or adsorbed at a time is too little; moreover, as the contact area between a small roller brush and the ground is also small, the rubbish is very likely to escape, thus greatly affecting the dust suction efficiency.

In view of this, the present application discloses an autonomous cleaning robot, which is provided with a variable dust collection channel composed of two scrapers at the peripheral of a suction port, wherein in a first state, the second scraper of the autonomous cleaning robot rises or ascends to away from a surface to be cleaned, so that the autonomous cleaning robot can collect rubbish on the ground of a large area, and by a blocking effect of the first scraper, it can effectively collect the rubbish such as hair, dust and debris into the variable dust collection channel; and in a second state, the second scraper of the autonomous cleaning robot descends to contact the surface to be cleaned, so that the variable dust collection channel and the communicated suction port form a dust suction channel, and the rubbish is sucked into the suction port by means of the suction force of the vacuum, and then sucked into the dust suction channel. During dust suction, as the first scraper and the second scraper are both in contact with the surface to be cleaned, the rubbish on the ground is not liable to escape to the outside of the variable dust collection channel, thus a strong dust suction ability and high cleaning efficiency can be achieved. In addition, since the autonomous cleaning robot in the present application removes the side brush and the roller brush, it is not easily entangled with the flexible obstacles (such as wires, cables, ropes, ribbons, leftover of cloth, etc.). Thereby, the situation that the autonomous cleaning robot cannot move or even fall over due to the entanglement is effectively avoided.

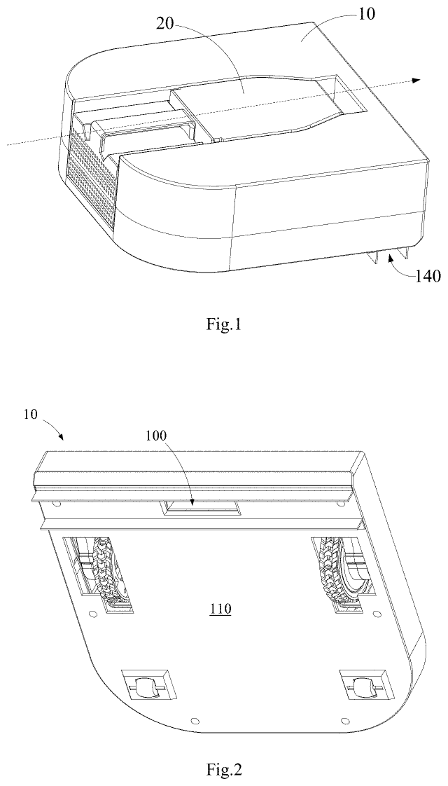

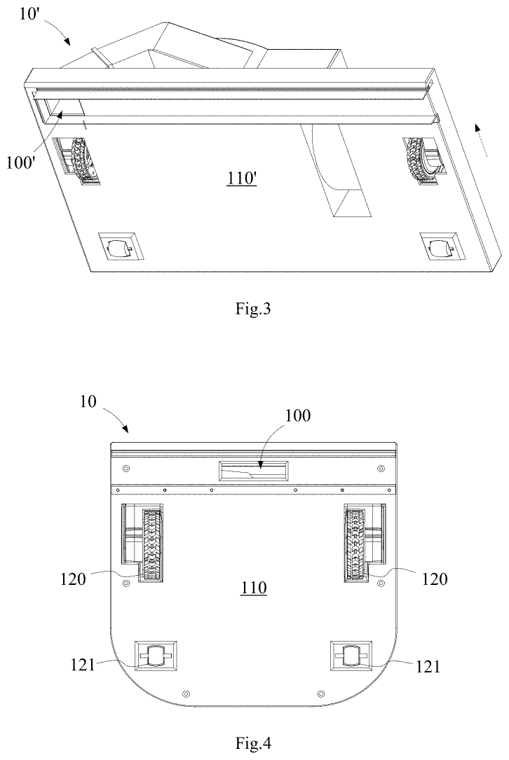

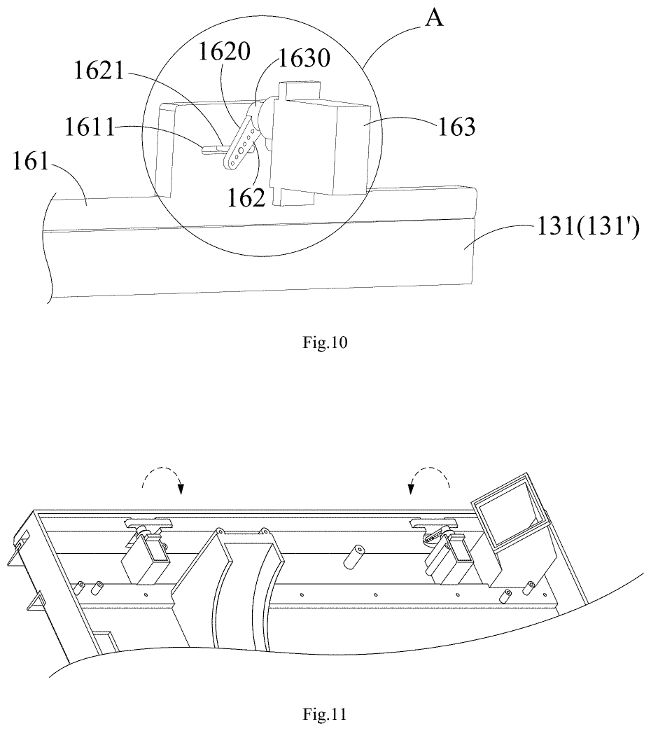

To facilitate understanding, in the description of the following embodiments of the present application, implementations of the autonomous cleaning robot in two forms will be described. Please refer to FIGS. 1, 2, 4, 6, 8, 10 and 13 to 17 for implementations or embodiments relating to the first form; and refer to FIGS. 3, 5, 7 to 12 and 18 to 20 for implementations or embodiments relating to the second form. The scraper structure shown in FIG. 8 and the drive structure shown in FIG. 10 are both applicable to the autonomous cleaning robot in the first form and in the second form.

Please refer to FIG. 1, which shows a structure diagram of the autonomous cleaning robot of the present application in an embodiment in the first form. As shown, the autonomous cleaning robot of the present application includes a robot body 10, a drive system, a control system and a dust suction assembly and a variable dust collection channel 140.

To facilitate understanding and clear expression, in the embodiments of the present application, a direction in which the drive system drives the robot body 10 to advance is defined as the front direction (i.e. the direction indicated by the dotted arrow in FIG. 1); correspondingly, a direction opposite to the front direction of the robot body 10 is defined as the rear direction. It should be understood that the side of the robot body 10 in the front direction is defined as the front side or front end; and the other side of the robot body 10 away from the front side or front end is defined as the rear side or rear end.

Please refer to FIG. 2, which shows a schematic diagram at a bottom view of the autonomous cleaning robot of the present application in an embodiment in the first form. As shown, the robot body 10 includes an assembly section (not shown) and a suction port 100 disposed on the bottom of the robot body and towards the surface to be cleaned. It is easy to understand that generally the outer surface of the autonomous cleaning robot towards the ground or the surface to be cleaned is referred to as the bottom surface, and correspondingly, the outer surface of the autonomous cleaning robot which is opposite to the bottom surface is referred to as the top surface. In general, the surface to be cleaned is the horizontal plane where the region to be cleaned is located, such as the floor, tabletop, or the like. Further, in other situations, the surface to be cleaned is, for example, a plane perpendicular to a side surface of a bookcase, or a non-horizontal surface at the outer side of an object. Generally, the robot body 10 has a housing (not shown) with a top surface and a side surface, and a chassis 110, and is approximately a semi-ellipse cylindrical structure (also known as D-shaped structure). When the autonomous cleaning robot moves (the movement includes at least one of forward movement, backward movement, steering, and rotation), the autonomous cleaning robot body with the D-shaped structure has better environmental adaptability. For example, during movement, it can reduce the probability of collision with surrounding objects (such as furniture, walls, etc.) or reduce the strength of the collision to reduce damage to the autonomous cleaning robot itself and the surrounding objects, and it is more advantageous in steering or rotation. However, it is not limited thereto. In some embodiments, the autonomous cleaning robot body may also be, for example, a rectangular body structure, a triangular column structure, or a flat cylindrical structure, or the like.

For example, please refer to FIG. 3, which shows a schematic diagram at a bottom view of the autonomous cleaning robot of the present application in an embodiment in the second form. As shown, the robot body 10′ includes an assembly section (not shown) and a suction port 100′ disposed on the bottom of the robot body and towards the surface to be cleaned. In the embodiments of the present application, the direction in which the drive system drives the robot body 10′ to advance is defined as the front direction (i.e. the direction indicated by the dotted arrow in FIG. 3); correspondingly, the direction opposite to the front direction of the robot body 10′ is defined as the rear direction. It should be understood that the side of the robot body 10′ in the front direction is defined as the front side or front end; and the other side of the robot body 10′ away from the front side or front end is defined as the rear side or rear end. As shown, the suction port 100′ is located at a side of the front end of the robot body 10′. The robot body 10′ has a housing (not shown) comprising a top surface and a side surface and a chassis 110′, and it is generally a rectangular structure. When the autonomous cleaning robot is the rectangular structure, the autonomous cleaning robot can thoroughly clean some surface such as corners formed by wall surfaces, without dead corners, which is difficult for a flat cylindrical structure to clean, and the cleaning coverage areas is larger. In practical applications, the autonomous cleaning robot shown in FIG. 3 has a wider cleaning surface, and is more applicable to ground cleaning in large venues such as airports and shopping malls.

The chassis can be integrally formed by materials such as plastic, and includes a plurality of pre-formed grooves, recesses, clamping parts or other similar structures, and is used for mounting or integrating related devices or components. In some embodiments, the housing can also be integrally formed by materials such as plastic, and it is complementary with the chassis and can protect the devices or components mounted to the chassis. The top surface of the housing can also be provided with other devices. For example, in some embodiments, one or more image acquisition devices such as camera can be provided on the top surface of the housing, and the structure and configure information of the image acquisition device will be detailed later. In some embodiments, a sound pickup can be provided on the top surface of the housing, and is used for collecting ambient sound from the autonomous cleaning robot during the cleaning operation or voice instructions from the user. In some embodiments, a microphone can be provided on the top surface of the housing and is used for broadcasting voice information. In some embodiments, a touch screen can be provided on the top surface of the housing so as to achieve better experience in human-machine interaction.

The chassis and the housing of the autonomous cleaning robot can be detachably combined by various suitable means (e.g., screw, buckle, etc.), and after being joined together, the chassis and the housing can form a package structure which has an accommodation space. The accommodation space can be used for accommodating various devices or components of the autonomous cleaning robot. For example, in the embodiment, the accommodation space can be used for accommodating the drive system, the control system, the dust suction assembly and other related devices or components. The dust suction assembly is detachably assembled in the accommodation space, and occupies a part of the accommodation space, and the dust suction assembly is disassembled or fixed through a buckle structure or a magnetic structure. The part of the accommodation space occupied by the dust suction assembly forms the assembly section. In some embodiments, the assembly section is disposed at the center of the robot body, and others such as the drive system and the control system occupy the other part of the accommodation space respectively. For example, as shown in FIG. 1, the drive system and the control system are respectively arranged on both ends of the accommodation space, thus the assembly section with a certain size is formed in the middle, and the assembly section is used for assembling the dust suction assembly.

The chassis is also provided with a suction port (also called dust suction port), which is disposed on the bottom of the autonomous cleaning robot and the opening thereof is towards the surface to be cleaned. In some embodiments, the dust suction port is provided at the front end of the robot body, so that the autonomous cleaning robot contacts the dirt such as dust and debris more quickly and collects the dirt through the dust suction port. The dirt includes, but is not limited to, soft debris, lump object, strip object and hard debris. The soft debris includes, for example, paper scraps, plastic sheets and dust. The lump object includes, for example, the clot of hair and plastic bag. The strip object includes, for example, electric wire, thread residue, iron wire and cloth strip. The hard debris includes, for example, rice grains, paper clip, stone, pens, and other debris often generated in living environment and office environment, which is not exhaustive here. The size of various dirt is generally smaller than the diameter of the dust suction port and can enter the cleaning device of the autonomous cleaning robot by means of an air stream.

The drive system includes the drive wheels, wherein the drive wheels are disposed on opposite sides of the robot body and configured to drive the robot body to move. Please refer to FIGS. 4 and 5. FIG. 4 shows a bottom view of the autonomous cleaning robot of the present application in an embodiment in the first form, and FIG. 5 shows a bottom view of the autonomous cleaning robot of the present application in an embodiment in the second form. In the autonomous cleaning robot in the first form shown in FIG. 4, the drive wheels 120 are mounted at opposite sides along the chassis 110, and generally the drive wheels 120 are arranged at the rear end of the suction port 100, so that the suction port 100 is located at the foremost end of the robot body, thereby providing a space in designing a longer dust suction channel. The drive wheels are used for driving the autonomous cleaning robot to reciprocate back and forth or perform a rotational motion or curvilinear motion, etc. according to a planned movement trajectory, or used for driving the autonomous cleaning robot to adjust the pose, and providing two contact points between the robot body 10 and the floor surface. The drive wheels 120 can have a biased-drop suspension system, which is movably fastened, such as rotatably mounted to the robot body 10, and receives a spring bias which is downward and away from the robot body. The spring bias enables the drive wheels 120 to maintain contact and traction with the ground with a certain landing force to ensure that the treads of the drive wheels 120 are in full contact with the ground. In the present application, when the autonomous cleaning robot needs to turn or move curvilinearly, the rotational speed difference between the drive wheels 120 on the two sides used for driving the robot body 10 is adjusted by regulator to achieve steering. In some embodiments, the drive wheel can also be a crawler-type drive wheel. The crawler-type drive wheel includes a crawler, a first drive component, a second drive component, and the like. The crawler is engaged with the first drive component and the second drive component. The drive system drives the first drive component so as to drive the second drive component and the crawler to operate, thereby driving the autonomous cleaning robot to perform operations such as back and forth movement, steering, and the like. In this embodiment, with the crawler-type drive wheel, the autonomous cleaning robot can cross a higher plane better, such as thicker carpets, sills, etc., and the drive wheel is not prone to slip. Meanwhile, the crawler-type drive wheel is not easily entangled with the flexible obstacles, and the situation that the autonomous cleaning robot cannot move or even fall over due to the entanglement is effectively avoided.

Similarly, in the autonomous cleaning robot in the second form shown in FIG. 5, the drive wheels 120′ are mounted at opposite sides along the chassis 110′, and generally the drive wheels 120′ are arranged at the rear end of the suction port 100′, so that the suction port 100′ is located at the foremost end of the robot body, thereby providing a space in designing a longer dust suction channel. The drive wheels are used for driving the autonomous cleaning robot to reciprocate back and forth or perform a rotational motion or curvilinear motion, etc. according to a planned movement trajectory, or used for driving the autonomous cleaning robot to adjust the pose, and providing two contact points between the robot body 10′ and the floor surface. The drive wheels 120′ can have a biased-drop suspension system, which is movably fastened, such as rotatably mounted to the robot body 10′, and receives a spring bias which is downward and away from the robot body. The spring bias enables the drive wheels 120′ to maintain contact and traction with the ground with a certain landing force to ensure that the treads of the drive wheels 120′ are in full contact with the ground. In the present application, when the autonomous cleaning robot needs to turn or move curvilinearly, the rotational speed difference between the drive wheels 120′ on the two sides used for driving the robot body 10 is adjusted by regulator to achieve steering.

In some embodiments, the robot body may also be provided with at least one driven wheel (in some embodiments, the driven wheel is also referred to as an auxiliary wheel, caster wheel, universal wheel or the like) to stably support the body. For example, as shown in FIG. 4, the robot body 10 is provided with at least one driven wheel 121 the driven wheel 121 together with the drive wheels 120 on each side of the robot body 10 keep the balance of the robot body 10 in a moving state. The driven wheel 121 can be arranged at a rear portion of the robot body, and specifically, in a state as shown in FIG. 4, two driven wheels 121 are respectively arranged at the rear side of the drive wheels 120, and the driven wheels 121 together with the drive wheels 120 on each side of the robot body 10 keep the balance of the robot body 10 in the moving state. Similarly, as shown in FIG. 5, the robot body 10′ is provided with at least one driven wheel 121′ the driven wheel 121′ together with the drive wheels 120′ on each side of the robot body 10′ keep the balance of the robot body 10′ in a moving state. The driven wheel 121′ can be arranged at a rear portion of the robot body, and specifically, in a state as shown in FIG. 5, two driven wheels 121′ are respectively arranged at the rear side of the drive wheels 120′, and the driven wheels 121′ together with the drive wheels 120′ on each side of the robot body 10′ keep the balance of the robot body 10′ in the moving state.

In view of the weight of the whole autonomous cleaning robot, in the drive system, the drive wheels and a drive motor thereof are disposed at a front portion of the autonomous cleaning robot, and the modular vacuum part and the power assembly of dust suction assembly are disposed at a rear portion of the autonomous cleaning robot, such that the weight of the entire autonomous cleaning robot is balanced when the dust suction assembly is assembled on the autonomous cleaning robot.

To drive the drive wheels and the driven wheels, the drive system further includes a drive motor. The autonomous cleaning robot also includes at least one drive unit, such as a left wheel drive unit for driving the drive wheel on the left side and a right wheel drive unit for driving the drive wheel on the right side. The drive unit can include one or more processors (CPUs) or micro-processing units (MCUs) dedicated to control the drive motor. For example, the micro-processing unit is configured to convert information or data provided by the processing device into an electrical signal used for controlling the drive motor, and controls rotational speed, rotational direction and the like of the drive motor according to the electrical signal to adjust the moving speed and moving direction of the autonomous cleaning robot. The information or data is, for example, a deflection angle determined by the processing device. The processor in the drive unit and the processor in the processing device can be shared, or can be provided independently. For example, the drive unit serves as a slave processing device, and the processing device serves as a master device, and the drive unit performs motion control based on control of the processing device, or the drive unit shares the processor in the processing device. The drive unit receives the data provided by the processing device through a program interface. The drive unit is configured to control the drive wheels based on a movement control instruction provided by the processing device.

The control system is provided on the robot body, and is used to control the drive wheels. Typically, the control system is provided with a processor and a memory. In some embodiments, the control system is arranged on a circuit board of the robot body, and includes a memory and a processor, etc., and the memory and the processor are electrically connected with each other directly or indirectly to achieve data transmission or interaction. In some embodiments, the control system is electrically connected to the robot body via a first connector to control movement of the robot body. The control system is electrically connected to the dust suction assembly via a second connector electrically connected with the first connector to control the dust suction assembly, for example, to adjust the output power of the vacuum of the dust suction assembly. For example, the memory and the processor can be electrically connected with each another via one or more communication buses or signal lines. The control system also includes at least one software module stored in the memory in the form of software or firmware. The software module is configured to store various programs executed by the autonomous cleaning robot, for example, a path planning program for the autonomous cleaning robot. The processor is configured to execute the program to control the autonomous cleaning robot to perform a cleaning operation.

In some embodiments, the processor comprises an integrated circuit chip with signal processing capability; or a general purpose processor, for example, a digital signal processor (DSP), an application specific integrated circuit (ASIC), a discrete gate or transistor logic device or a discrete component, which can implement or execute the methods, steps, and logic block diagrams disclosed in the embodiments of the present application. The general purpose processor can be a microprocessor or any conventional processor or the like. In some embodiments, the memory can include a random access memory (RAM), a read only memory (ROM), a programmable read only memory (PROM), an erasable programmable read-only memory (EPROM), an electric erasable programmable read-only memory (EEPROM), or the like. The memory is configured to store a program, and the processor executes the program after receiving an execution instruction.

The control system is also be provided with sensing system used for sensing relevant signals and physical quantities to determine position information and motion state information, etc. of the mobile device. In some embodiments, the sensing system can include image acquisition device, laser direct structuring (LDS) device, and various sensing devices, wherein these devices can be combined differently according to product requirements. For example, in some embodiments, the sensing system can include image acquisition device and various sensing devices. In some embodiments, the sensing system can include LDS device and various sensing devices. In some embodiments, the sensing system can include image acquisition device, LDS device, and various sensing devices. In the above embodiments, there can be one or more image acquisition devices.

In some embodiments, at least one image acquisition device such as camera can be provided on a top surface (e.g. a central area of the top surface, the front end relative to the central area of the top surface, or the rear end relative to the central area of the top surface) of the body, or a side surface of the body, or at the intersection of the top surface and the side surface; furthermore, an angle between the optical axis of the at least one camera and the plane formed by the top surface is an acute angle or close to a right angle, the camera is used to capture an image of the operating environment of the autonomous cleaning robot for subsequent VSLAM (Visual Simultaneous Localization and Mapping) and object recognition. For example, in some embodiments, a monocular camera can be provided on the top surface of the body, and the monocular camera can calculate pose change of the camera through matching adjacent images, and perform triangular ranging through two perspectives to obtain depth information of corresponding points, and achieve positioning and mapping through an iterative process. In some embodiments, a binocular camera can be provided on the top surface of the body, and the binocular camera can calculate depth information by a triangulation method, and achieve positioning and mapping through an iterative process. In some embodiments, a fisheye camera can be provided on the top surface of the body, the fisheye camera protrudes from the top surface of the body, and a panoramic image can be obtained through the fisheye camera.

The sensing system can include various sensors for different uses, including, but not limited to, any one or combination of a pressure sensor, a gravity sensor, a ranging sensor, a cliff sensor, a drop sensor, a collision detecting sensor and the like.

In some embodiments, the pressure sensor can be arranged on a damping device of the drive wheel and determine whether the autonomous cleaning robot passes an uneven surface of a region to be cleaned by detecting the pressure change of the damping device, and when the autonomous cleaning robot passes an uneven surface, the pressure sensor outputs a pressure signal different from that on a flat ground because of the damping movement of the damping device. In some embodiments, the pressure sensor can be arranged on a buffering assembly (e.g. a bumper or the like) of the autonomous cleaning robot, and when the buffering assembly collides with an obstacle, the pressure sensor outputs a pressure signal generated based on the collision because of the depressurizing vibration of the buffering assembly.

In some embodiments, the gravity sensor can be arranged at any position of the robot body and determine whether the autonomous cleaning robot passes an uneven surface of a region to be cleaned by detecting the gravity value of the autonomous cleaning robot, and when the autonomous cleaning robot passes an uneven surface, the gravity value of the autonomous cleaning robot also changes accordingly.

In some embodiments, a plurality of obstacle detectors are arranged at the periphery of the front end of the robot body. The obstacle detector includes, but is not limited to, a cliff sensor, a ranging sensor, a collision detecting sensor and the like, and is used to detect surrounding objects in an environment to be cleaned, so that the autonomous cleaning robot adjusts its moving direction and/or a moving pose according to a received feedback signal, to avoid colliding with the obstacle or falling off a cliff. In some embodiments, the robot body is provided with a cliff sensor on at least one side, and the cliff sensor is located at the front end and near the bottom of an edge of the autonomous cleaning robot. In some embodiments, there are a plurality of, such as four cliff sensors, these cliff sensors are disposed at the front end of the bottom of the robot body respectively, and used to transmit a sensing signal to the ground and sensing the cliff based on the received signal reflected by the ground. The cliff sensors for example are optical sensors using various forms of light. In some embodiments, the cliff sensor can be an infrared sensor having an infrared signal transmitter and an infrared signal receiver, so that it can sense the cliff by transmitting infrared rays and receiving reflected infrared rays, and further can analyze the depth of the cliff.

In some embodiments, a ranging sensor can also be provided to detect a change in the vertical distance between the chassis of the autonomous cleaning robot and the ground, and/or to detect a change in the distance between the autonomous cleaning robot and a surrounding object. The ranging sensor can be disposed on the buffering assembly of the autonomous cleaning robot, so that the ranging sensor can detect a change in the distance between the autonomous cleaning robot and other object in the environment to be cleaned when the autonomous cleaning robot is moving. As described above, taking the buffering assembly as a bumper as an example, the bumper is an arc-shaped sheet and is arranged at the front end of the autonomous cleaning robot body. In a specific implementation, the ranging sensor includes an infrared ranging sensor, and there are a plurality of infrared ranging sensors. For example, the infrared ranging sensors can be four pairs, six pairs or eight pairs, and symmetrically disposed at two opposite sides of the bumper respectively. Each pair of infrared ranging sensor has an infrared signal transmitter and an infrared signal receiver. A beam of infrared light is emitted by the infrared signal transmitter, and the light is reflected after being irradiated to an object, then the reflected infrared light is received by the infrared signal receiver. The distance between the autonomous cleaning robot and the object is calculated according to the time difference between the infrared emission and reception. In a specific implementation, the ranging sensor can include a ToF sensor, wherein ToF (Time of Flight) is time-of-flight technology. There can be a plurality of ToF sensors. For example, there are two ToF sensors, which are symmetrically arranged on two opposite sides of the bumper respectively. The modulated near-infrared light is emitted by the ToF sensor, and the light is reflected after encountering an object, and the reflected light is received by the ToF sensor, thus the distance between the autonomous cleaning robot and the object is calculated through calculating the time difference or phase difference between the light emission and reception. In a specific implementation, the ranging sensor can include an ultrasonic ranging sensor, which can be arranged on a foremost end at the center of the bumper. The ultrasonic ranging sensor has an ultrasonic transmitter and an ultrasonic receiver. The ultrasonic transmitter is used to transmit ultrasonic waves. When the transmitter starts to transmit ultrasonic waves, a counter starts the time. The ultrasonic waves propagate in the air, and are reflected back immediately upon being blocked by an object. When the ultrasonic receiver receives the reflected ultrasonic waves, the counter stops the time immediately. In this way, the distance between the autonomous cleaning robot and the object is calculated according to the time recorded by the counter.

In some embodiments, the ranging sensor can also be arranged on the chassis of the autonomous cleaning robot and determine whether the autonomous cleaning robot passes an uneven surface of the region to be cleaned by detecting the distance between the chassis of the autonomous cleaning robot and the floor surface. The ranging sensor can detect a change in the distance between the chassis of the autonomous cleaning robot and the ground when the autonomous cleaning robot passes the uneven surface.

To protect the autonomous cleaning robot, a buffering assembly is further provided at the front end of the robot body, and is used to avoid damage caused by collision between the autonomous cleaning robot and a surrounding object in the environment to be cleaned. In some embodiments, the buffering assembly can be, for example, a bumper, and used for buffering collision between the autonomous cleaning robot and a surrounding object during movement. The bumper is generally an arc-shaped sheet, and is mounted at a forward portion of a side panel of the robot body. An elastic structure is disposed between the bumper and the robot body to form a retractable elastic space therebetween. When the autonomous cleaning robot collides with an obstacle, the bumper retracts toward the robot body under force, to absorb and eliminate the impact force generated by the collision with the obstacle, thereby protecting the autonomous cleaning robot. In some embodiments, the bumper can have a multi-layer structure, or a soft strip can also be provided at the outer side of the bumper, or the like. Correspondingly, to detect whether the autonomous cleaning robot collides with an obstacle or a wall, in some embodiments, a collision detecting sensor can be provided on the robot body, the collision detecting sensor is associated with the bumper, and mainly includes a light transmitter, a light receiver and a retractable rod between the light transmitter and the light receiver, wherein the retractable rod is retractable because of collision. In a normal state, the retractable rod is in an initial position, and a light path between the light transmitter and the light receiver is unblocked. When the autonomous cleaning robot collides with an obstacle, the bumper at the front of the autonomous cleaning robot retracts toward the robot body due to impact by the obstacle. At this time, the retractable rod on the inner side of the bumper is retracted under force and positioned between the light transmitter and the light receiver, and the light path between the light transmitter and the light receiver is cut off, thus the collision detecting sensor emits a collision signal.

In some embodiments, the sensing device can also include other sensors, such as a magnetometer, an accelerometer, a gyroscope, an odometer and the like. In practical applications, the above types of sensors can also be used in combination to achieve better detection and control effects.

After acquiring signals though the above-mentioned various sensing devices, the autonomous cleaning robot can process the signals through the control system to achieve different functions. For example, in some embodiments, the autonomous cleaning robot transmits the image information acquired by the camera to a positioning and navigation system or an object recognition system or the like, so as to plan travelling path or avoid obstacle or the like based on the information. Thus, the control system can include at least one of a positioning and navigation system, a mileage calculation system, a vision measurement system, an object recognition system, and a voice recognition system.

In some embodiments, the control system is provided with a positioning and navigation system, and the processor draws an instant map of the environment where the autonomous cleaning robot is located by using a positioning algorithm (such as SLAM) according to object information fed back by the laser ranging device in the sensing system, or the processor draws an instant map of the environment where the autonomous cleaning robot is located by using a positioning algorithm (such as VSLAM) according to image information captured by the camera device in the sensing system, thereby the most efficient and reasonable cleaning path and cleaning mode are planned based on information of the drawn instant map, thus the cleaning efficiency of the autonomous cleaning robot can be improved. Furthermore, in combination with distance information, speed information, pose information and the like fed back by other sensors (such as pressure sensor, gravity sensor, ranging sensor, cliff sensor, drop sensor, collision detecting sensor, magnetometer, accelerometer, gyroscope, odometer, etc.) in the sensing system, the current operation state of the autonomous cleaning robot is judged, so that a next operation strategy can be provided for different situations, and a corresponding control instruction is transmitted to the autonomous cleaning robot.

In some embodiments, the control system is further provided with a mileage calculation system. The processor acquires an instruction indicated arriving at a target predetermined position, and calculates the cleaning path according to the target predetermined position and the initial position where the autonomous cleaning robot is currently located. After the autonomous cleaning robot starts working, the processor calculates the mileage of the autonomous cleaning robot in real time according to speed data, acceleration data, and time data fed back by the motor.

In some embodiments, the control system is further provided with an object recognition system. The processor compares the image information captured by the camera in the sensing system with an object image stored in a known image database of the memory, and obtains type information and position information of surrounding objects in real time, thereby achieving more accurate map construction and navigation function. In some embodiments, an object recognition model acquired in advance by deep learning is built in the autonomous cleaning robot. During working of the autonomous cleaning robot, an image captured by the camera device is input into the object recognition model, and the object information (such as position information, shape information, etc.) in the input image is calculated, so that the object type in the image is identified. The object recognition model includes a training convolutional neural network. The convolutional neural network (CNN) is a kind of architecture of deep neural network, which is closely related to image processing. The weight-sharing network structure of the convolutional neural network makes it more similar to a biological neural network. Such structure not only reduces the complexity of the network model, but also reduces the number of weights. Such network structure is highly invariant for translation, scaling, tilting or other forms of deformation. The convolutional neural network can use the image as an input of the network directly, thus avoiding the complex feature extraction and data reconstruction process in the traditional recognition algorithm.

In some embodiments, the control system is further provided with a visual measurement system. Similar to the object recognition system and the positioning and navigation system, the vision measurement system is also based on SLAM or VSLAM. By measuring the environment to be cleaned through the camera device in the sensing system, the vision measurement system identifies a marked object and main features in the environment to be cleaned. Furthermore, the vision measurement system performs a navigation based on a map of the environment to be cleaned drawn by triangulation principle, to determine the current location of the autonomous cleaning robot and a cleaned area and an uncleaned area.

In some embodiments, the control system is further provided with a voice recognition system. Through the voice recognition system, a user can send a voice command to an audio medium device to control the autonomous cleaning robot, so that the user can control the autonomous cleaning robot even if the user is inconvenient to operate the manual input device that can be operated together with the autonomous cleaning robot; or the user can also receive notifications about the state of the autonomous cleaning robot without physically close to the autonomous cleaning robot. The voice recognition system can also be used for providing audible notifications to the user, and can provide the notifications to the user when the autonomous cleaning robot navigates autonomously around the home (in some cases, away from the user). Since the voice recognition system can issue the audible notifications, the user can be notified of the state of the autonomous cleaning robot without diverting the user's visual attention.

Generally, during the movement and cleaning of the cleaning robot, rubbish on the ground such as hair, dust and debris is agitated or adsorbed mainly by the roller brush arranged at the center of the bottom of the cleaning robot, and then the rubbish on the ground is sucked by the suction force of the vacuum into the suction port provided above the roller brush, so as to collect the rubbish on the ground. Therefore, on the one hand, the larger the roller brush is, the more rubbish on the ground can be agitated or adsorbed; and accordingly, the area of the provided suction port is increased, the suction force of the vacuum is reduced, and dedusting ability of the cleaning robot is weakened. However, if the roller brush is small, the rubbish on the ground agitated or adsorbed at a time is too little, thus greatly affecting the dust suction efficiency. On the other hand, as described above, proving a large roller brush can affect the suction force of the vacuum, and as the function force is reduced, it's difficult for the rubbish on the ground to be sucked into the air inlet channel through the suction port above the roller brush, and the rubbish on the ground is liable to escape from the periphery of the roller brush; moreover, as the contact area between a small roller brush and the ground is also small, leading to a small contact area to be cleaned and low cleaning efficiency, and is also liable to cause escaping of the rubbish on the ground.

Therefore, in the autonomous cleaning robot of the present application, the scraper structure is provided at the peripheral of the suction port to form the variable dust collection channel with a large area, thus the coverage area to be cleaned is increased. Moreover, during movement of the autonomous cleaning robot, the autonomous cleaning robot performs sweeping and scraping to collect dust in the first state, and the rubbish on the ground is collected in the variable dust collection channel. Then the autonomous cleaning robot switches to the second state, and the rubbish on the ground is sucked into the suction port by means of the suction force of the vacuum. As the scraper structure is provided at the peripheral of the suction port, escaping of the rubbish on the ground collected in the variable dust collection channel is prevented effectively.

The variable dust collection channel is arranged at the peripheral of the suction port, and is used for sweeping and scraping to collect dust in the first state and forming the dust suction channel communicated with the suction port in the second state. The variable dust collection channel includes the first scraper and the second scraper, wherein the first scraper is arranged at a first side of the suction port and contacts with the surface to be cleaned, the first scraper is used for sweeping and scraping to collect dust when the robot body travels; and the second scraper is movably arranged at a second side of the suction port, wherein when the second scraper contacts with the surface to be cleaned, the first scraper and the second scraper form the dust suction channel communicated with the suction port. In some embodiments, the first scraper is located at the rear side of the suction port, and the second scraper is located at the front side of the suction port, and the first scraper and the second scraper are arranged parallel to each other. In some embodiments, the first scraper is movable arranged at the first side of the suction port, so it is easy to clean or replace the first scraper.

In the first state, the second scraper is driven by a drive motor to rise or ascend to away from the surface to be cleaned, so that during advancing of the autonomous cleaning robot, the second scraper cannot obstruct the rubbish on the ground from entering into the variable dust collection channel. When the rubbish on the ground enters into the variable dust collection channel, as the first scraper is provided at the rear side of the suction port, the rubbish is obstructed, thus the rubbish on the ground cannot escape around and is thereby collected in the variable dust collection channel. When the autonomous cleaning robot switches to the second state, the second scraper is driven by the drive motor to descend and contact the surface to be cleaned, thus the first scraper, the second scraper and the suction port form the dust suction channel, and the dust suction channel has the scraper structures in both front and rear for obstruction, thus the rubbish on the ground is prevented from escaping outward effectively; moreover, as both the first scraper and the second scraper at the front side and the rear side of the dust suction channel contact with the surface to be cleaned, air flows from the front direction and the rear direction during movement of the autonomous cleaning robot are obstructed, so that the suction force of the vacuum is greatly enhanced and increased.

It should be understood that the state of the second scraper is not limited to being rise or ascend to away from the surface to be cleaned in the first state, or being descend to contact with the surface to be cleaned in the second state. When the autonomous cleaning robot operates along the wall, the second scraper can also maintain a down state and contact with the surface to be cleaned. In this case, the first scraper and the second scraper form a dust suction channel that is opened on one side, and the rubbish such as hair, dust, debris, etc. by the wall is sucked into the dust suction channel from the opening and then is sucked into the suction port. In this way, the autonomous cleaning robot can effectively clean the rubbish by the wall and the cleaning ability is stronger.

It is easy to understand that on the one hand, in order to improve the cleaning efficiency, the dust suction channel cannot too short, which leads that little rubbish on the ground is collected and is sucked by the vacuum through the suction port at each time. Therefore, in some embodiments, the length of the communicated dust suction channel formed by the first scraper and the second scraper is equal to or greater than the spacing between the drive wheels at the two sides of the robot body, so that enough rubbish on the ground can be sucked at each time. On the other hand, if the dust suction channel is too long, unnecessary contact with furniture, wall surfaces and the like is increased, which increases abrasion. Furthermore, if the dust suction channel extends beyond the robot body of the autonomous cleaning robot, it can also affect the moving, steering and other motion of the autonomous cleaning robot. Therefore, in some embodiments, the length of the communicated dust suction channel formed by the first scraper and the second scraper is equal to the width of the robot body, so that the overall moving, steering and other motion of the autonomous cleaning robot are not affected while maximizing the dust suction efficiency, and good appearance of the autonomous cleaning robot is maintained.

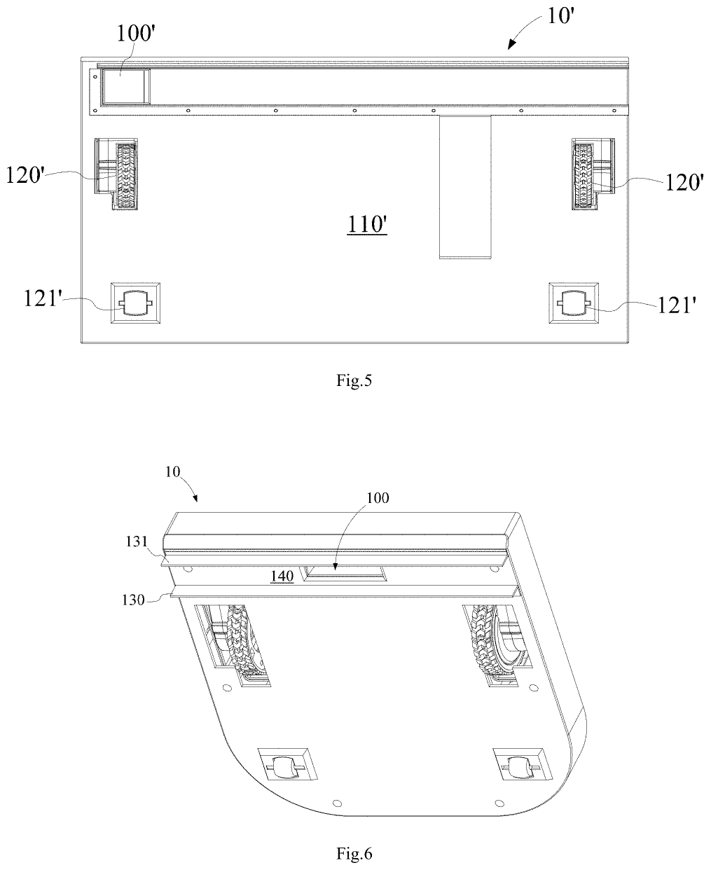

Please refer to FIG. 6, which shows a schematic diagram at a bottom view of the autonomous cleaning robot of the present application in an embodiment in the first form. As shown in FIG. 6, the direction in which the drive system drives the robot body 10 to advance is defined as the front direction, and the variable dust collection channel 140 is arranged at the peripheral of the suction port 100, and the variable dust collection channel 140 is used for sweeping and scraping to collect dust in the first state, and forming the dust suction channel communicated with the suction port in the second state. The variable dust collection channel 140 includes a first scraper 130 and a second scraper 131, wherein the first scraper 130 is located at the rear side of the suction port 100, and the second scraper 131 is located at the front side of the suction port 100, and the first scraper 130 and the second scraper 131 are arranged parallel to each other. The first scraper 130 contacts with the surface to be cleaned, and is used for sweeping and scraping to collect dust when the robot body 10 moves; and the second scraper 131 is movably arranged at the second side of the suction port 100, and when the second scraper 131 contacts with the surface to be cleaned, the first scraper 130 and the second scraper 131 form the dust suction channel communicated with the suction port 100.

In the embodiments of the present application, as shown in FIG. 6, the dust suction channel formed by the first scraper 130 and the second scraper 131 has two air inlets arranged on either side of the robot body, and the suction port 100 is located in the middle of the dust suction channel. Thus, when the autonomous cleaning robot is in the first state, the second scraper 131 is driven by a drive motor to rise or ascend to away from the surface to be cleaned, and the second scraper 131 collects the rubbish on the ground into the variable dust collection channel 140 during the movement of the autonomous cleaning robot. In the second state, the second scraper 131 is driven by the drive motor to descend and contact the surface to be cleaned, and the second scraper and the first scraper 130 form the dust suction channel communicated with the suction port 100. The vacuum sucks the rubbish on the ground into the suction port 100 by means of the suction force. At that time, as the suction port 100 is arranged in the middle of the dust suction channel, the rubbish on the ground at both sides of the dust suction channel moves toward the middle of the dust suction channel by means of the suction force, and is sucked into the suction port 100 in the middle of the dust suction channel.

To make the dust suction channel closer to a closed space when the autonomous cleaning robot is in the second state, so that the suction force of the vacuum is stronger, in some embodiments, a blocking structure (not shown) can be further provided, the blocking structure is movably arranged at the left side or right side of the suction port, so that in the second state, the first scraper, the second scraper and the blocking structure form a dust suction channel with an opening at only one end, in view of this, most air flow can be obstructed, so that the suction force of the vacuum is stronger and the dust suction ability is higher. In this case, when the opening is towards the wall, the rubbish such as hair, dust, debris, etc. by the wall is sucked into the dust suction channel and then is sucked into the suction port under the force of the vacuum. In this way, the autonomous cleaning robot can effectively clean the rubbish by the wall and the cleaning ability is stronger.

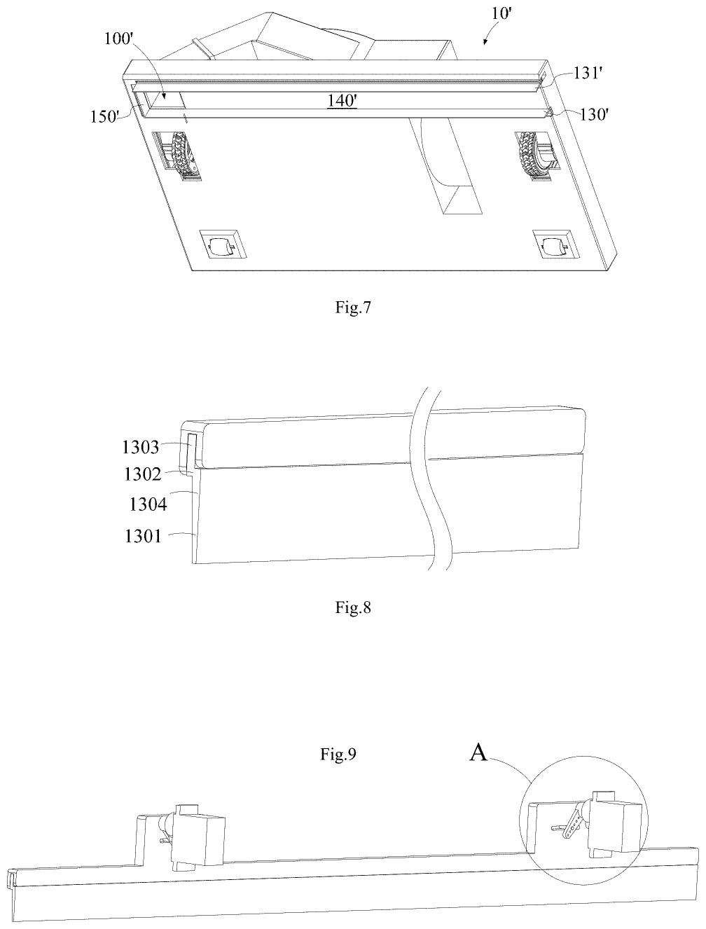

For example, please refer to FIG. 7 which shows a schematic diagram at a bottom view of the autonomous cleaning robot of the present application in an embodiment in the second form. As shown in FIG. 7, the direction in which the drive system drives the robot body 10′ to advance is defined as the front direction, and the variable dust collection channel 140′ is arranged at the peripheral of the suction port 100′, and the variable dust collection channel 140′ is used for sweeping and scraping to collect dust in the first state, and forming the dust suction channel communicated with the suction port in the second state. The variable dust collection channel 140′ includes a first scraper 130′ and a second scraper 131′, wherein the first scraper 130′ is located at the rear side of the suction port 100′, and the second scraper 131′ is located at the front side of the suction port 100′, and the first scraper 130′ and the second scraper 131′ are arranged parallel to each other. In the embodiments of the present application, as shown in FIG. 7, the dust suction channel formed by the first scraper 130′ and the second scraper 131′ has an air inlet on one side, and the suction port 100′ is located on an end away from the air inlet of the dust suction channel. Thus, during sucking dust in the second state, the rubbish on the ground moves toward one end of the suction port 100′ due to the action of the suction force, and is sucked at the end into the suction port 100′. At one side of the suction port 100′ is further provided movably a blocking structure 150′. In the first state, the blocking structure 150′ can prevent rubbish on the ground from escaping outward of the side, such as when the autonomous cleaning robot advances or changes its direction, and a better sweeping and scraping to collect dust effect is achieved; and in the second state, the first scraper 130′, the second scraper 131′ and the blocking structure 150′ form a dust suction channel 140′ with only one end being open, so that the rubbish on the ground is more unlikely to escape to the outside of the dust suction channel, and the dust suction ability is stronger.

To reduce friction with the surface to be cleaned, so as to reduce wear and tear caused by long-term friction, the blocking structure can be made of a flexible material, so that the blocking structure can be elastically deformed to some extent during contact with the hard surface or obstacle, to reduce abrasion of the blocking structure. Moreover, after the blocking structure leaves the hard surface or obstacle, the blocking structure can quickly restore its shape; in this way, the service life of the blocking structure can be prolonged while maintaining the cleaning ability. In addition, as the flexible material has a buffering effect, noise is reduced greatly. The flexible material includes synthetic fibers, animal or plant fibers, or other fibrous materials known in the art, such as polyester rubber and the like; more importantly, the variable dust collection channel made of the flexible material achieves a better closing effect when the scrapers on both sides contact the ground.

During operation of the autonomous cleaning robot, the autonomous cleaning robot switches between the first state and the second state after detected a certain condition is satisfied. In some embodiments, the control system is further configured to control the switching between the first sate and the second state of the variable dust collection channel at a preset time interval. For example, the preset time interval is 2 seconds (but not limited to it); during advancing of the autonomous cleaning robot, the autonomous cleaning robot is in the first state initially, and the second scraper rises or ascends and the first scraper performs sweeping and scraping to collect dust; after 2 seconds of sweeping and scraping, the autonomous cleaning robot switches to the second state, and the second scraper descends and contacts the surface to be cleaned, and the vacuum sucks the rubbish on the ground collected in the variable dust collection channel in above 2 seconds into the suction port. After another 2 seconds, the autonomous cleaning robot switches to the first state and continue working. In some situations, there may be much rubbish on the ground, and a large amount of rubbish on the ground can be collected in a short time; if the working time in the second state is short, it is very likely that the rubbish on the ground is not entirely sucked into the suction port, but the autonomous cleaning robot has already switched back to the first state, thus affecting the dust suction efficiency. Or if the rubbish on the ground is little, frequent switching to the second state increases the idle rate of the vacuum and causes energy waste. Therefore, in some embodiments, the working time in the first state and the working time in the second state of the autonomous cleaning robot can be different. For example, the autonomous cleaning robot performs sweeping and scraping to collect dust for 2 seconds in the first state, then switches to the second state, performs dust suction for 3 seconds in the second state, and then switches back to the first state; or the autonomous cleaning robot performs sweeping and scraping to collect dust for 4 seconds in the first state, then switches to the second state, performs dust suction for 2 seconds in the second state, and then switches back to the first state.

In some embodiments, the control system is further configured to control the switching between the first sate and the second state of the variable dust collection channel according to a power output by the dust suction assembly. When negative pressure power output by the dust suction assembly is larger, the suction force of the vacuum is stronger, much rubbish on the ground can be sucked at each time, and the frequency of switching between the first state and the second state can be reduced accordingly; similarly, when negative pressure power output by the dust suction assembly is smaller, the suction force of the vacuum is weaker, and the frequency of switching between the first state and the second state can be increased accordingly.

In some embodiments, the control system is further configured to control the switching between the first state and the second state of the variable dust collection channel according to the moving distance or speed of the drive wheels. The autonomous cleaning robot can switch to the second state for dust suction at a preset moving distance. When the autonomous cleaning robot is in the second state, the autonomous cleaning robot is in a static state or a moving state. The switching between the first state and the second state of the variable dust collection channel can also be performed according to the speed of the drive wheels. For example, when the speed of the drive wheels is detected to be faster, the autonomous cleaning robot is also at a faster moving state at that time, and the frequency of switching between the first state and the second state is increased to achieve quick sweeping and scraping to collect dust and dust suction so as to avoid missing some rubbish on the ground; and when the speed of the drive wheels is detected to be slower, the autonomous cleaning robot is also at a slower moving state at that time, and the frequency of switching between the first state and the second state is reduced to achieve sweeping and scraping to collect dust and dust suction thoroughly. In specific implementations, data of the moving distance or speed of the drive wheels can be acquired from drive wheel motor, and the data of the moving distance or speed can also from a navigation system or an inertia measurement system.

In some embodiments, the autonomous cleaning robot further includes a debris detection system used to detect a debris state, and the control system is further configured to control the switching between the first sate and the second state of the variable dust collection channel according to the debris state detected by the debris detection system. If the debris detection system detects the current debris state is that much rubbish is present on the surface to be cleaned, the frequency of switching between the first sate and the second state of the variable dust collection channel is increased by the control system, to achieve a better cleaning effect and prevent missing some rubbish on the ground; and if the debris detection system detects the current debris state is that substantially no rubbish is present on the surface to be cleaned, the frequency of switching between the first sate and the second state of the variable dust collection channel is reduced properly by the control system, to reduce energy consumption. The debris detection system described in the CN107669215A can herein incorporated by reference, and will not be described in detail herein.

In some embodiments, the first scraper or the second scraper includes a mounting part, a connecting part, a reinforcing part and a blade part for contacting the surface to be cleaned. Please refer to FIG. 8, which shows a structure diagram of a scraper of the autonomous cleaning robot of the present application in an embodiment in the first form or second form. As shown In FIG. 8, the first scraper or the second scraper includes a mounting part 1303, a connecting part 1302, a reinforcing part 1304 and a blade part 1301 for contacting the surface to be cleaned. In an exemplary embodiment, the mounting part 1303, the connecting part 1302, the reinforcing part 1304 and the blade part 1301 are an integrally formed structure. The mounting part 1303 is configured to enable the blade part 1301 to be detachably assembled to the autonomous cleaning robot; the blade part 1301 is used for sweeping the surface to be cleaned, such as the ground or tabletop, when the autonomous cleaning robot operates; and the connecting part 1302 connects the mounting part 1303 and the blade part 1301. On the one hand, the first scraper or the second scraper needs to be bent to be stably assembled to the autonomous cleaning robot; on the other hand, during operation of the autonomous cleaning robot, the first scraper or the second scraper needs to contact the surface to be cleaned constantly or intermittently, and during contact with the surface to be cleaned, the friction between the first scraper or the second scraper and the surface to be cleaned, and collision between the first scraper or the second scraper and objects or obstacles and other factors can lead the blade part 1301 of the first scraper or the second scraper to be bent under force. Due to factors such as long-term use and material aging over time, the blade part 1301 is prone to breakage. Therefore, the first scraper or the second scraper further includes the reinforcing part 1304, and the reinforcing part 1304 is arranged on the connecting part 1302, and is used for supporting and reinforcing the blade part 1301.

In other words, by supporting and reinforcing the blade part 1301, the reinforcing part 1304 can eliminate or reduce the influence of the bending force on the blade part 1301, so that even if the blade part 1301 bears forces repeatedly in the long term and suffers from gradual material aging after being used for a long time, the breakage of the blade part 1301 at the connecting part 1302 can be avoided or delayed so as to prolong the service life of the blade part 1301 as much as possible, and avoid affecting the normal use of the autonomous cleaning robot, thereby extending the consumable replacement cycle while ensuring basic functions, saving the cost and providing a good user experience.

During the movement of the autonomous cleaning robot, in order to reduce the collision force, friction and resistance generated when the first scraper or the second scraper is in contact with a hard surface or an obstacle, the first scraper or the second scraper can be made of a flexible material, so that the first scraper or the second scraper can be elastically deformed to some extent during contact with the hard surface or obstacle, to reduce abrasion of the first scraper or the second scraper. Moreover, after the first scraper or the second scraper leaves the hard surface or obstacle, the first scraper or the second scraper can quickly restore its shape; in this way, the service life of the first scraper or the second scraper can be prolonged while maintaining the cleaning ability. In addition, as the flexible material has a buffering effect, noise is reduced greatly. The flexible material includes synthetic fibers, animal or plant fibers, or other fibrous materials known in the art, such as polyester rubber and the like.

In some embodiments, the second scraper is driven by a drive mechanism to go up and down, and the drive mechanism includes a lifting member, a swing member and a drive motor. Please refer to FIGS. 9 and 10. FIG. 9 shows a schematic diagram of a drive structure of the autonomous cleaning robot of the present application in an embodiment in the first or second form, wherein the drive structure is illustrated by a round area A in FIG. 9. FIG. 10 shows an enlarged diagram of A in FIG. 9. As shown in FIG. 10, the drive mechanism 160 is shown in the round area A, and the drive mechanism includes a lifting member 161, a swing member 162 and a drive motor 163. The lifting member 161 includes a lifting body for fixing the second scraper (131 or 131′), and the lifting body is provided with a slot (such as elongated slot) 1611. The swing member 162 includes a swing arm 1620 and a connecting rod 1621 arranged vertically on a first end of the swing arm 1620; the connecting rod 1621 is inserted into the elongated slot 1611, and when the swing arm 1620 swings, the connecting rod 1621 performs rectilinear motion within the elongated slot 1611 to make the second scraper (131 or 131′) on the lifting member 161 to descend and contact the surface to be cleaned or ascend to away from the surface to be cleaned. During operation of the autonomous cleaning robot, the drive motor 163 provides a swing power to drive a second end of the swing arm 1620 coupled perpendicularly with an output shaft 1630 of the drive motor to perform swing movement, thereby making the swing arm 1620 to perform swing movement; as the connecting rod 1621 is connected to the first end of the swing arm 1620, the connecting rod 1621 moves under force. As the connecting rod 1621 is inserted into the elongated slot 1611, and the elongated slot 1611 is a transversely arranged slot, the connecting rod 1621 moves left and right only within the elongated slot 1611 under force, thereby making the lifting body to move up and down, that is, making the second scraper (131 or 131′) to ascend or descend. There are one or more drive mechanisms. In the case of multiple drive mechanisms, the wing directions of the swing arms driven by the motors among the multiple drive mechanisms can be same or opposite.

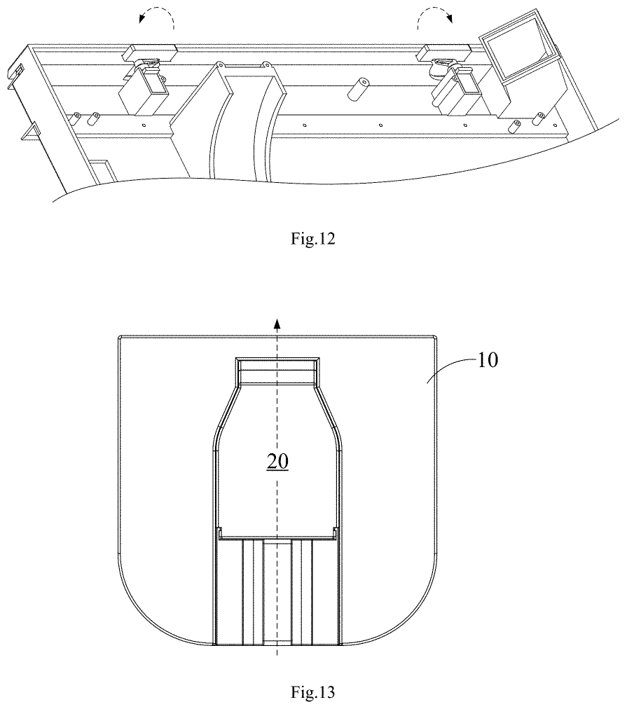

In an exemplary embodiment, the second scraper is provided with two drive structures, and is disposed symmetrically on the left and right sides of the second scraper body respectively, to ensure the left and right ends of the second scraper maintaining synchronous movement during the lifting movement thereof, as the state shown in FIGS. 11 and 12. Please refer to FIGS. 11 and 12. FIG. 11 shows schematically action of the drive structure in one direction of the autonomous cleaning robot of the present application in an embodiment in the second form, and FIG. 12 shows schematically action of the drive structure in another direction of the autonomous cleaning robot of the present application in an embodiment in the second form. As shown in FIG. 11, the autonomous cleaning robot is provided with two drive mechanisms, the drive motors in the drive mechanisms drive the two swing arms to swing respectively. The directions indicated by the dotted arrow in the figures are swing directions of the swing arms, wherein the swing direction of the left swing arm is clockwise, and the swing direction of the right swing arm is counterclockwise; and the swing directions of the two swing arms are opposite. In this case, the drive motor drives the second end of the swing arm coupled perpendicularly with the output shaft of the drive motor to perform swing movement in the direction indicated by the dotted arrow, thereby making the swing arm to perform swing movement; and the swing arm makes the connecting rod connected thereto to move under force. The connecting rod moves left and right within the elongated slot under force, thereby making the lifting body to descend. The lifting body descends, and then makes the second scraper mounted to the lifting body to descend and contact the surface to be cleaned.

As shown in FIG. 12, The directions indicated by the dotted arrow in the figures are swing directions of the swing arms, wherein the swing direction of the left swing arm is counterclockwise, and the swing direction of the right swing arm is clockwise; and the swing directions of the two swing arms are opposite. In this case, the drive motor drives the second end of the swing arm coupled perpendicularly with the output shaft of the drive motor to perform swing movement in the direction indicated by the dotted arrow, thereby making the swing arm to perform swing movement; and the swing arm makes the connecting rod connected thereto to move under force. The connecting rod moves left and right within the elongated slot under force, thereby causing the lifting body to ascend. The lifting body descends, and then causes the second scraper mounted to the lifting body to ascend away from the surface to be cleaned.

In some embodiments, the second scraper does not vertically go up and down, but rotates around the mounting part, rotates forward and rises to away from the surface to be cleaned or rotates backwards and contacts the surface to be cleaned. In some embodiments, the second scraper is driven by a drive mechanism to go up and down, and the drive mechanism includes a rotating member (not shown) and a drive motor. The rotating member comprises a rotating body for fixing the second scraper and a rotating shaft provided on the rotating body. The output shaft of the drive motor is coupled with the rotating shaft of the rotating member, for providing a rotary power to the rotating shaft in the working state to make the second scraper on the rotating body to contact the surface to be cleaned or rise away from the surface to be cleaned.

During operation of the autonomous cleaning robot, the drive motor provides the rotary power and drives the rotating shaft of the rotating component coupled with the output shaft thereof to rotate, thereby making the rotating member to rotate. The second scraper is fixed to the rotating component through the rotating body. During rotation, the rotating component makes, through the rotating shaft and the rotating body, the second scraper to rotate forward and rise away from the surface to be cleaned or rotate backward and contact the surface to be cleaned.

The dust suction assembly is installed in the assembly section, and an air inlet channel thereof is communicated with the suction port, the dust suction assembly is used to suck dust under a negative pressure. In some embodiments, the dust suction assembly is a hand-held dust suction device. The hand-held dust suction device is assembled in the assembly section of the robot body in a tool-free manner. It should be understood that tool-free means that the hand-held dust suction device can be assembled in the assembly section through operation by the user without using any tools. Of course, in some embodiment, the hand-held dust suction device can be assembled in the assembly section of the robot body by tools and so that the hand-held dust suction device and the robot body is used as a whole autonomous cleaning robot.

Please refer to FIG. 13, which shows a top view of the autonomous cleaning robot of the present application in an embodiment in the first form. In the embodiment shown in FIG. 13, in view of the counterweight of the whole autonomous cleaning robot, the direction in which the power system drives the robot body 10 to advance is defined as the front direction, i.e. the direction indicated by the dotted arrow in FIG. 13 is defined as the front direction. The hand-held dust suction device 20 is assembled in the assembly section of the robot body and symmetrically disposed on the central axis of the robot body 10 in the front-rear direction, suchthat the forces on the drive wheels on the left and right sides of the autonomous cleaning robot are equal, which is more conducive to the driving and control of autonomous cleaning robot.

In some embodiments, the robot body 10 is provided with a first connector electrically connected to the control system, and the hand-held dust suction device 20 is provided with a second connector correspondingly electrically connected to the first connector (not shown). In some embodiments, the first and second connectors are plug-in connectors, such as pin-type connectors, slot-type connectors, or gold finger connectors, etc. The first connector is electrically connected to the control system and the second connector. In some embodiments, there is a pin-type connector or a slot-type connector (also called gold finger) between the control system and the hand-held dust suction device 20, which is used to electrically connect them, so as to control the vacuum of the hand-held dust suction device 20, for example, adjust the output power of the vacuum of the hand-held dust suction device 20; and there is a pin-type connector or a slot-type connector between the control system and the robot body 10, which is used to fixedly electrically connect them, so as to control the motion state of the robot body. By using the pin-type connector or the slot-type connector, a reliable electrical connection between the control system, and the robot body and the hand-held dust suction device is ensured, and connection failures such as poor contact are avoided.

In the present application, the control system controls the vacuum of the hand-held dust suction device 20 through the electrical connection between the first connector and the second connector. For example, the control system adjusts the output power of the vacuum according to planned path; or the control system adjusts the output power of the vacuum according to the sensed type of dirt such as dust and debris; or adjusts the output power of the vacuum according to the detected type of floor such as wooden floor and carpet. In addition, the control system can also analyze the electric quantity of the battery of the hand-held dust suction device 20 through the electrical connection between the first connector and the second connector to determine whether to return to a charging base for charging. Correspondingly, the power part can acquire charging electric energy from the charging base of the autonomous cleaning robot through the second connector.

It is readily understood by those skilled in the art that the working modes of the hand-held dust suction device include an off-line working mode and an on-line working mode. That is, in the case where the hand-held dust suction device is separated from the autonomous cleaning robot, a mode in which the hand-held dust suction device works alone is called an off-line working mode. In the off-line working mode, the hand-held dust suction device is used as an whole, and the user can use the hand-held dust suction device independently to perform a dust suction operation. Correspondingly, in the case where the hand-held dust suction device is connected to the autonomous cleaning robot, a mode in which the hand-held dust suction device is assembled in the autonomous cleaning robot and works integrally with the autonomous cleaning robot is called an on-line working mode.

To detect which working mode the hand-held dust suction device is in, the hand-held dust suction device further includes a mode detecting module electrically connected to the second connector, and is used to detect the working mode of the hand-held dust suction device. The mode detecting module determines the working mode of the hand-held dust suction device by detecting an electrical connection of the connector and the autonomous cleaning robot. For example, when the mode detecting module detects that the electrical connection between the connector and the autonomous cleaning robot is a closed circuit (for example, the level acquired from a detecting point is high), it indicates that the hand-held dust suction device is assembled on the autonomous cleaning robot and connected to the autonomous cleaning robot, and the hand-held dust suction device is in the on-line working mode. When the mode detecting module detects that the electrical connection between the connector and the autonomous cleaning robot is an open circuit (for example, the level acquired from the detecting point is low), it indicates that the hand-held dust suction device is separated from the autonomous cleaning robot and is not connected to the autonomous cleaning robot, and the hand-held dust suction device is in the off-line working mode.

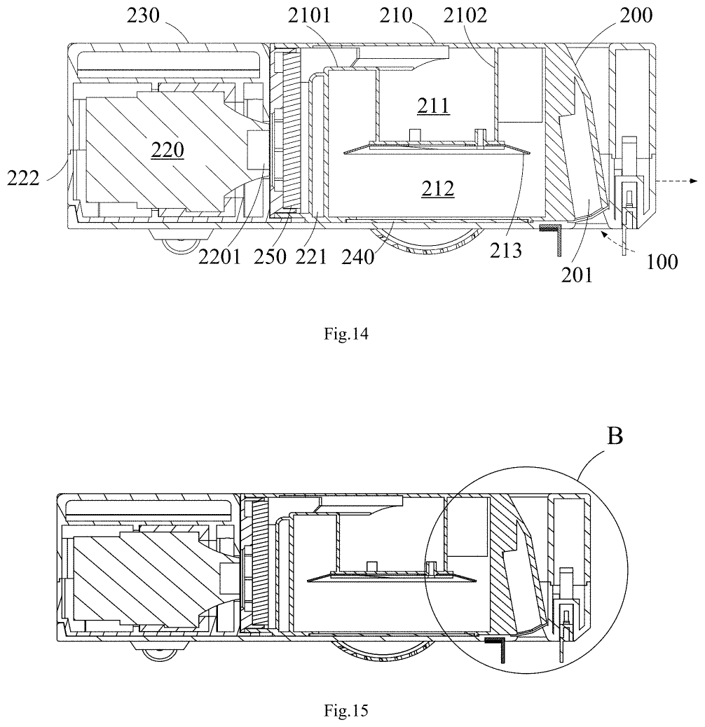

Please refer to FIG. 14, which shows a sectional view of the autonomous cleaning robot of the present application in an embodiment in the first form. As shown, the hand-held dust suction device is assembled in the assembly section of the robot body, and includes, from rear to front, a power part assembled in a modular integrated manner, a vacuum part, a separation and dust collection part 210, and a dust suction head 200 coupled to the suction port 100. The direction indicated by the arrow in FIG. 14 is defined as the front direction. The power part is used for providing power supply to the vacuum part. In some embodiments, the power part can provide power supply to the control system and the drive system through the electric connection between the first connector and the second connector.

In some embodiment, the hand-held dust suction device can also be assembled in the assembly section of the robot body by tools, and the hand-held dust suction device and the robot body is used as a whole autonomous cleaning robot.

In some embodiment, to facilitate operation by the user, the hand-held dust suction device of the present application is assembled in the assembly section of the robot body in a tool-free manner. It should be understood that tool-free means that the hand-held dust suction device can be assembled in the assembly section through operation by the user without using any tools, and the hand-held dust suction device and the robot body is used as a whole autonomous cleaning robot. So that the user can use the autonomous cleaning robot as two devices very conveniently, when it needs to clean the ground or floor, the hand-held dust suction device is assembled to the robot body to be used as a cleaning robot or a dust suction robot. When it needs to clean regions difficult for the cleaning robot or dust suction robot to reach, such as sofas, the user can detach the hand-held dust suction device from the robot body by hands without any tool, and use the hand-held dust suction independently.

In some embodiments, the dust suction head 200 and the separation and dust collection part 210 are tool-free structures, and the dust suction head can be replaced or configured differently according to actual needs, to achieve a better cleaning effect. In some embodiments, the housing of the hand-held dust suction device is provided with a hand-held part 230, which is, for example, a handle or grasp structure (such as a groove or lug) to facilitate gripping, as the state shown in FIG. 14. In different embodiments, the hand-held part 230 can also be a pull-out handle or a flip-type handle.

In the design of the hand-held dust suction device, considering the counterweight of the power part assembled in a modular integrated manner, the vacuum part, the separation and dust collection part 210, and the dust suction head 200, the hand-held part 230 is arranged on the upper surface of the hand-held dust suction device to improve the operational convenience of the hand-held dust suction device, thereby more labor-saving when the operator uses the hand-held dust suction device as a hand-held vacuum cleaner. In this way, the operator saves more effort in use as compared with the solution of designing the hand-held part at the front, rear, left or right side. In the embodiment shown in FIG. 14, since the power part and the vacuum part in the hand-held dust suction device account for most of the weight of the whole device, the position of the hand-held part 230 in the present application is set to the upper side of the battery part and the vacuum part in the hand-held dust suction device, so as to be more labor-saving for the user.

As described above, in practical applications, to facilitate grasping the hand-held dust suction device, in some embodiments, the housing is further provided with the hand-held part 230. The hand-held part 230 extends along the front-rear direction and connects two ends of the housing. In the embodiment, the housing encapsulates the vacuum part and the battery part, and the hand-held part 230 is fixedly arranged on the upper surface of the housing, and the position thereof is corresponding to the vacuum part and the battery part in the housing. The length of the hand-held part 230 can be set to a length that is convenient for human hand to grasp, and a plurality of protrusions can also be provided on the surface of the hand-held part 230 to increase friction and facilitate gripping.

The hand-held dust suction device is assembled in the assembly section of the robot body, and can be assembled and detached without using any tool. For example, the hand-held dust suction device can be assembled in the assembly section in a detachable manner through a clamping structure or a magnetic absorption structure.

When the autonomous cleaning robot performs a cleaning task on the ground (floor) as a sweeping robot, a cleaning robot or a dust suction robot, due to long-time traveling of the autonomous cleaning robot, the robot body bumps or vibrate (of course, part of vibration may also be originated from the working vibration of the vacuum), which can affect the stability of the hand-held dust suction device assembled in the assembly section. Thus, in some embodiments, the robot body is provided with a plurality of first clamping structures, and the hand-held dust suction device is provided with a plurality of second clamping structures correspondingly clamped to the first clamping structures (not shown).

It can be understood that when the hand-held dust suction device is assembled in the assembly section, in order to achieve better connection between the hand-held dust suction device and the robot body, the first clamping structure and the second clamping structure are configured as mutually corresponding embedded structures. For example, in some embodiments, the first clamping structure is a protrusion structure, and the second clamping structure is a clamping slot structure correspondingly the protrusion structure for clamping; or the first clamping structure is a clamping slot structure, and the second clamping structure is a protrusion structure correspondingly the clamping slot structure for clamping.

To ensure the stability of the hand-held dust suction device assembled in the assembly section, in particular, to ensure the obturation between the dust suction port of the robot body and the dust suction head of the hand-held dust suction device, the front side of the robot body is further provided with a first clamping structure, and correspondingly, the dust suction head of the hand-held dust suction device is provided with a second clamping structure corresponding to the first clamping structure. In an exemplary embodiment, the first clamping structure provided on the front side of the robot body is a clamping hook, and correspondingly, the second clamping structure provided on the side wall of the dust suction head of the hand-held dust suction device and corresponding to the first clamping structure is s clamping slot. When the hand-held dust suction device is assembled in the assembly section, the combining of the front end of the hand-held dust suction device is stable through the clamping hook and the clamping slot, thereby ensuring the obturation or sealing performance between the dust suction port and the dust suction head, and the dust suction efficiency will not reduce due to air leakage.

Or in some embodiments, the hand-held dust suction device is assembled in the assembly section of the robot body through a magnetic absorption structure, wherein the robot body is provided with a plurality of first magnetic absorption structures, and the hand-held dust suction device is provided with a plurality of second magnetic absorption structures in one-to-one correspondence with the first magnetic absorption structures. In this way, the hand-held dust suction device can be connected to the robot body through a magnetic attractive force, and can be detached very conveniently when separation is needed.

In some embodiments, the robot body can be further provided with an in-place detecting component (not shown) to detect the assembly state of the hand-held dust suction device assembled in the robot body. In some embodiments, the in-place detecting component can include a Hall sensor and a magnet, wherein the Hall sensor is arranged in the assembly section of the robot body, and the Hall sensor is connected to the control system on the chassis, and the magnet is arranged at a side or the bottom of the hand-held dust suction device. In practical applications, when the hand-held dust suction device is in the assembly state, as the magnet on the hand-held dust suction device corresponds to the Hall sensor at the assembly section, due to changes of magnetic field and the magnetic lines of force being cut of, the Hall sensor outputs a pulse signal, thereby determining that the hand-held dust suction device is in right place or is correctly placed in the assembly section; and when the magnet does not correspond to the Hall sensor in the assembly section, the Hall sensor does not output a pulse signal, and the control system outputs an alarm signal because the corresponding pulse signal is not received, and so as to prompt the user that the hand-held dust suction device is not put in place.

In practical applications, there are situations where the existing autonomous cleaning robot is not applicable in some environments to be cleaned. For example, when the user wants to clear away dust in corners of a bookcase, or when the user wants to clear away hair on a sofa, or the like, the existing autonomous cleaning robot cannot autonomously perform the cleaning operation in this case. Therefore, the autonomous cleaning robot of the present application provides different functions including autonomous cleaning and manual cleaning by assembling and detaching the hand-held dust suction device, and the user can determine whether or not to detach the hand-held dust suction device according to different environment to be cleaned, so it is highly practical, simply to operate and easy to use, and has a good user experience.

As described above, when it needs to clean the ground, the hand-held dust suction device can be assembled to the robot body, that is, the hand-held dust suction device is in the on-line working mode, the autonomous cleaning robot can perform the cleaning operation according to a pre-set procedure or cleaning plan. In this situation, the cleaning range of the autonomous cleaning robot is larger, such as the floor of the entire room, or the like, and the autonomous cleaning robot can accomplish the cleaning by taking more working time to reduce the power requirement. Moreover, in view of the battery life of the autonomous cleaning robot, the power of the vacuum in the assembled state is often turned down. When the user holds the hand-held dust suction device for cleaning, long-term work fatigues the user, and on the other hand, it often needs to carry out small-range targeted cleaning in a region difficult to clean by the autonomous cleaning robot in the assembled state or a region with dirt difficult to remove. In this situation, the vacuum needs to be adjusted to a greater power.

Therefore, in some embodiments, the housing of the hand-held dust suction device can be further provided with an adjustment button for turning on the vacuum, turning off the vacuum, and adjusting the output power of the vacuum, in order to switch on or off the vacuum, or adjust the output power of the vacuum according to different application scenarios or usage states. Generally, the adjustment button can be arranged on an outer surface of the housing of the hand-held dust suction device. The adjustment button can be one or more. In some embodiments, there may be two adjustment buttons, wherein one adjustment button is used to turn on or turn off the vacuum according to the number(s) of press, and the other adjustment button is used for adjusting the output power of the vacuum, and the adjusting manner is set to select different preset output powers according to the number(s) of press. For example, when the user presses the adjustment button for adjusting the power once, it indicates selecting a low power, and when the user presses the adjustment button twice, it indicates selecting a high power. Alternatively, in some embodiments, there are three adjustment buttons, wherein one adjustment button is used to turn on or turn off the vacuum according to the number(s) of press, one adjustment button indicates power increase, and another adjustment button indicates power decrease; and the power adjusting manner is set to increase or decrease the output power based on pressing one of the adjustment buttons for adjusting the power by the user. Alternatively, in some embodiments, there are a plurality of adjustment buttons, wherein one adjustment button indicates turning on the vacuum, one adjustment button indicates turning off the vacuum, and other multiple adjustment buttons represent a plurality of preset power levels, for example, three adjustment buttons marked with a first or low level, second or middle level, and third or high level, respectively, and the user can make selections as needed. In some embodiments, the adjustment button is also configured with a status indicator that indicates the status of the button to provide a better human-machine experience. In a specific implementation, the status indicator may have different choices in display color and display manner. For example, the status indicator may display different colors according to different output powers (e.g. high-power mode, low-power mode, standby mode), or adopt different display manners (e.g. normally on, breathing light mode, flashing and the like).

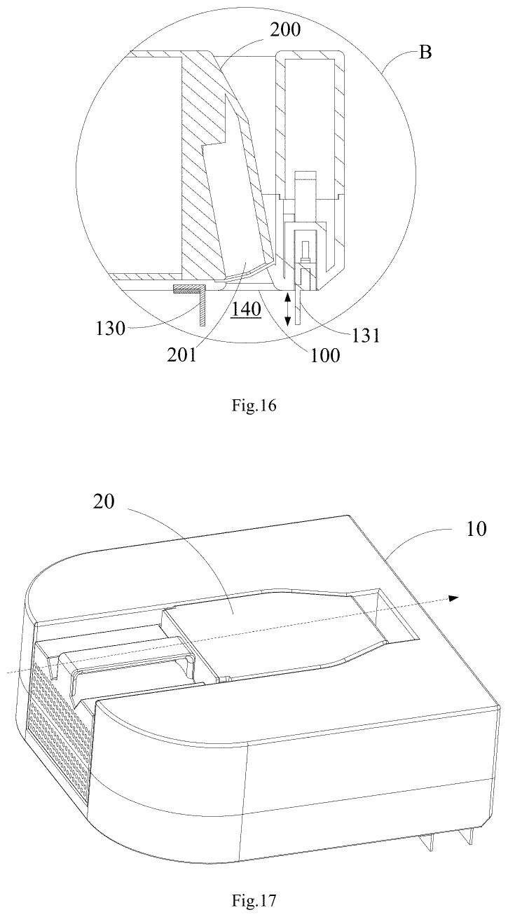

Please refer to FIGS. 15 and 16. FIG. 15 shows a sectional view of the autonomous cleaning robot of the present application in an embodiment in the first form, wherein the round area B in FIG. 15 shows in FIG. 16. FIG. 16 shows an enlarged diagram of B in FIG. 15. As shown in FIG. 16, one end of the dust suction head 200 is communicated with the suction port 100, and the other end thereof is communicated with an air inlet 201 of the separation and dust collection part to form a channel for air flow. The variable dust collection channel 140 composed of the first scraper 130 and the second scraper 131 is disposed at the peripheral of the suction port 100. In the first state, the second scraper 131 is driven by a drive motor to rise or ascend to away from the surface to be cleaned, so that during advancing of the autonomous cleaning robot, the second scraper 131 cannot obstruct the rubbish from entering into the variable dust collection channel 140. When the rubbish enters into the variable dust collection channel 140, as the first scraper 130 is provided at the rear side of the suction port 100, so that the rubbish is obstructed, thus the rubbish cannot escape around and thereby is collected in the variable dust collection channel 140. When the autonomous cleaning robot switches to the second state, the second scraper 131 is driven by the drive motor to descend and contact the surface to be cleaned, such that the first scraper 130, the second scraper 131 and the suction port 100 form a dust suction channel (i.e., the variable dust collection channel 140), and the dust suction channel has the scraper structures in both front and rear directions for obstruction, thus effectively preventing the rubbish from escaping outward; moreover, as both the first scraper 130 and the second scraper 131 at the front side and the rear side of the dust suction channel contact the surface to be cleaned, air flows from the front direction and the rear direction during movement of the autonomous cleaning robot are obstructed, so that the suction force of the vacuum is greatly enhanced. The directions indicated by the arrows in FIG. 16 are the moving directions of the second scraper 131 in the first state and the second state.

In some embodiments, a seal ring (not shown) is disposed at one end of the dust suction head 200 in communication with the dust suction port 100, and is used for sealing a possible gap between the dust suction head 200 and the dust suction port 100 to increase the suction efficiency.

In some embodiments, the dust suction head 200 is integrally formed with the separation and dust collection part. It should be understood that in practical applications, the required shape, size or width of the dust suction head may be different for different environments to be cleaned. For example, for the cleaning of a crack between a door and its frame, the dust suction head is a relatively elongated shape.

In some embodiments, the dust suction head 200 is provided with a docking structure (not shown), the docking structure is used for docking various sucker fittings suitable for different application scenarios. The sucker fittings can have different structures for specific functions, such as a duckbill sucker for a slit part scenario or a flat sucker for a large-area plane (such as a bed), or the other likes.

As described above, as the hand-held dust suction device also have functions of a hand-held vacuum cleaner, it is designed to have high-power dust suction performance (relative to the dust suction power when the device is used as a cleaning robot). To this end, the hand-held dust suction device needs a longer body to optimize its air duct design to meet its high power requirement. Thus, the autonomous cleaning robot of the present application optimizes the design of the air duct, that is, with a cyclone separation design to avoid possible blockage of the air duct due to the air duct being too short, for example, to avoid the blockage of a filter by a large amount of garbage or dust due to the air duct being too short.

Please refer to FIG. 14, as shown in FIG. 14, in some embodiments, the separation and dust collection part 210 includes a housing, an air duct inlet 201 communicated with the dust suction head 200, and a chamber, wherein the chamber includes a separation chamber 211 and a dust collection chamber 212 communicated with the separation chamber 211 and disposed on the lower side of the separation chamber 211. In some embodiments, the separation and dust collection part is assembled on the housing in a tool-free manner. It should be understood that tool-free means that the separation and dust collection part can be assembled on the housing through operation by the user without using any tools. The separation and dust collection part can be conveniently cleaned or replaced in the tool-free manner.

In the embodiment shown in FIG. 14, the chamber further includes an outer filter 2101 and an inner filter 2102, wherein the outer filter 2101 is an annular sidewall structure which forms an annular air cavity; or the outer filter 2101 and a part of the housing together form an annular air cavity. The outer filter 2101 and the entire housing disposed on the outer side forms an accommodating cavity 221, or a gap between the outer filter 2101 and a part of the housing disposed on the outer side forms an accommodating cavity 221. The inner filter 2102 is configured as an annular sidewall structure in the annular air cavity, and the middle part of the inner filter 2102 forms the separation chamber 211. In some embodiments, a flexible blade 213 is disposed between the separation chamber 211 and the dust collection chamber 212, and a gap is formed between the flexible blade 213 and the wall of the chamber, so that dust or debris in the separation chamber can fall into the dust collection chamber 212 through the gap. The material of the flexible blade 213 is, for example, elastic rubber. When the separated debris in the separation chamber is larger and cannot fall into the dust collection chamber 212 through the gap, it can bend and deform the flexible blade 213 by its weight to fall into the dust collection chamber 212.

When the autonomous cleaning robot moves, dirt such as dust and debris enters into the dust suction port 100 due to the suction force generated by the vacuum, and then enters into the dust suction head 200 communicated with the dust suction port 100, then enters into the separation and dust collection part 210 through the air inlet 201, and is separated in the separation and dust collection part 210. In general, the radial size of dust particles in the dirt is smaller than the radial size of the debris, and the diameter of a first filter hole provided on the outer filter 2101 is larger than the radial size of the dust particles and smaller than the radial size of the debris; and the diameter of a second filter hole provided on the inner filter 2102 is smaller than the radial size of the debris. Due to the action of the vacuum part, a large pressure difference is generated between the inside and the outside of the housing of the separation and dust collection part 210, thus an air stream is formed. The air stream carrying dirt such as dust and debris enters into the chamber from the air inlet 201, and moves along the inner wall of the annular air cavity to form a cyclone, wherein the radial size of the dust particles in the dirt is smaller than the radial size of the debris, and because the diameter of the first filter hole provided on the outer filter 2101 is larger than the radial size of the dust particles, and the radial size of the debris is larger than the diameter of the second filter hole provided on the inner filter 2102, due to a centrifugal force during movement with the cyclone, the light and small dust particles, enters into the accommodating cavity 221 through the first filter hole to stand, so as to be separated from the debris and no longer disturbed by the air stream. Due to the action of gravity, the debris heavier than the dust drops into the dust collection chamber 212 through the gap between the flexible blade 213 and the wall of the chamber, wherein the flexible blade 213 is used to make the collected debris is in a relatively stable space and not liable to run about, to facilitate cleaning later.

In some embodiments, the bottom of the dust collection chamber 212 is provided with a cover 240 that can be opened and closed to facilitate dumping the dirt inside the dust collection chamber 212 when the dust collection chamber 212 is full or needs to be cleaned. The cover further includes a fixing structure for fixing the cover to the dust collection chamber. In some embodiments, the cover and the dust collection chamber 212 can be connected and fixed by a hinge structure and a buckle structure, and the hinge structure can include, for example, a hinge with a simple structure. When it needs to dump the dirt such as dust and debris in the dust collection chamber 212, the buckle structure is opened, and cover is rotated relative to the bottom of the dust collection chamber 212 through the hinge, thereby achieving opening and closing of the cover. To clean the dust collection chamber 212 in time and to prevent the dirt in the dust collection chamber 212 from overflowing, in some embodiments, the dust suction head 200 and the separation and dust collection part 210 are made of a transparent material for more intuitive observation of the collection within the dust collection chamber 212.

In this case, after filtration or separation by the outer filter 2101 and the inner filter 2102, the light and small dust is collected in the accommodation chamber 221, and the debris is collected in the dust collection chamber 212, and the air stream originally carrying dirt such as dust and debris becomes a clean air stream, which is discharged from the separation and dust collection part 210 through the air outlet, and then enters into the vacuum 220 through the vacuum inlet 2201.

The vacuum part includes a vacuum inlet 2201 and a vacuum 220. In some embodiments, a filter assembly 250 is disposed on the passage between the separation and dust collection part 210 and the vacuum part, and a gap is formed between the filter assembly 250 and the accommodating chamber 221. The filter assembly 250 includes a filter element or a similar filter screen structure to further filter the air stream to remove possible residual dust, thereby avoiding that dust in the separation and dust collection part 210 escapes and damages the vacuum 220. The filter element or similar filter screen structure is detachable and can be reused, for example, these can be cleaned by brush or water. In some cases, the filter element or similar filter screen structure is a disposable consumable.

In the autonomous cleaning robot of the present application, the design of the air duct is optimized, that is, the length of the entire air duct is lengthened to meet the requirement on the air duct when the autonomous cleaning robot is used as a high-power hand-held vacuum cleaner. To this end, the dust suction port is disposed at the front end of the entire autonomous cleaning robot, and the air vent of the air duct is disposed at the rear end of the entire autonomous cleaning robot, so that the length of the entire air duct is almost equal to the length of the front and rear sides of the autonomous cleaning robot, as shown in FIG. 1 and FIG. 14. The vacuum part further includes the air vent 222, which is disposed at the rear end of the robot body. The air stream enters into the vacuum 220 through the vacuum inlet 2201 and is discharged from the hand-held dust suction device through the air vent 222. In some embodiments, the air vent 222 can be configured, for example, as a spaced-grid structure, and the gap of grids can be designed according to actual needs, characteristics of the vacuum, the size of the air vent, and the like. The height of the grids can be slightly lower than the height of the passage formed by the air stream passing through the vacuum 220, such that a flow space is also formed between the grid and the top of the passage. Further, the air vent 222 can also other structures, such as fins or through holes.

As described above, a filter element or a similar filter screen structure is arranged at the air outlet of the separation and dust collection part 210 to filter air, avoiding that dust in the separation and dust collection part 210 escapes and damages the vacuum 220. In order to avoid that the clogging of the filter element or the similar filter screen structure affects the air duct, the cross-sectional area of the air outlet of the separation and dust collection part 210 is usually large, and the vacuum inlet 2201 is much smaller than the air outlet of the separation and dust collection part 210. Therefore, the cross section of the connecting passage communicated the air outlet of the separation and dust collection part 210 with the vacuum inlet 2201 is also tapered, so that the air from the filter element or similar filter screen structure of the separation and dust collection part 210 enters into the vacuum 220 in a certain direction with as little loss as possible.

The robot body can be further provided with an in-place detecting component (not shown) in order to detect the assembly state of the separation and dust collection part 210 device assembled in the robot body. In some embodiments, the in-place detecting component can include a Hall sensor and a magnet, wherein the Hall sensor is arranged in the assembly section of the robot body, and the Hall sensor is connected to the control system on the chassis, and the magnet is arranged at a side or the bottom of the separation and dust collection part, or provided on the outer filter 2101 or on the inner filter 2102. In practical applications, when the separation and dust collection part 210 is in the assembly state, as the magnet on the separation and dust collection part 210 corresponds to the Hall sensor at the assembly section, due to changes of magnetic field and the magnetic lines of force being cut of, the Hall sensor outputs a pulse signal, thereby determining that the separation and dust collection part 210 is in right place or is correctly placed in the assembly section; and when the magnet does not correspond to the Hall sensor in the assembly section, the Hall sensor does not output a pulse signal, and the control system outputs an alarm signal because the corresponding pulse signal is not received, and so as to prompt the user that the separation and dust collection part 210 is not put in place.

When the autonomous cleaning robot performs the ground cleaning task, the autonomous cleaning robot often needs to go deep into the gap such as the bottom of a bed and the bottom of a cabinet for cleaning, so there is usually a limit on the height of the autonomous cleaning robot body. To avoid that in the on-line working mode, due to the very large height of the hand-held dust suction device, the autonomous cleaning robot cannot enter into the gap with a relatively low height when the device is assembled on the autonomous cleaning robot, the height of the hand-held dust suction device placed in the autonomous cleaning robot is set to be equal to or smaller than the height of the autonomous cleaning robot body. Please refer to FIG. 17, which shows a structure diagram of the autonomous cleaning robot of the present application in the on-line working mode in an embodiment in the first form. As shown, the direction in which the drive system drives the robot body to advance is defined as the front direction (i.e. the direction indicated by the dotted arrow in FIG. 17); the height of the hand-held dust suction device 20 placed in the autonomous cleaning robot is equal to or smaller than the height of the autonomous cleaning robot body 10, and the length of the hand-held dust suction device 20 placed in the autonomous cleaning robot in the front-rear direction is smaller than the length of the autonomous cleaning robot body 10 in the front-rear direction.

Due to the autonomous cleaning robot usually configured in a certain shape (such as a flat cylindrical structure) to increase environmental adaptability. When the autonomous cleaning robot moves (the movement includes at least one of forward movement, backward movement, steering, and rotation), the autonomous cleaning robot body of the flat cylindrical structure has better environmental adaptability. For example, during movement, it can reduce the probability of collision with surrounding objects (such as furniture, walls, etc.) or reduce the strength of the collision, thus reduce damage to the autonomous cleaning robot itself and the surrounding objects, and more conducive to steering or rotation. However, it is not limited thereto. In some embodiments, the autonomous cleaning robot body may also be, for example, a rectangular body structure, a triangular column structure, or a semi-elliptical column structure or a D-shaped structure (such as the autonomous cleaning robot shown in FIG. 17). Therefore, in order not to hinder the movement such as steering or rotation of the autonomous cleaning robot, and considering the overall aesthetics, the length of the hand-held dust suction device 20 placed in the autonomous cleaning robot in the front-rear direction is set to be smaller than the length of the autonomous cleaning robot body 10 in the front-rear direction.

The power part includes a battery part and a circuit part, and is used for supplying power to other electrical devices, such as the power system and the control system. The battery part can include a rechargeable battery (pack). For example, a conventional nickel-metal hydride (NiMH) battery is used, which is economical and reliable, or the battery part may also use other suitable rechargeable battery (pack) such as a lithium battery. Compared with the nickel-metal hydride battery, the lithium battery has higher volumetric specific energy than the nickel-metal hydride battery; and the lithium battery has no memory effect, and can be charged for immediate use, thus greatly improving the convenience. The power assembly further includes a battery recess, in which the rechargeable battery (pack) is mounted, and the battery recess can be sized according to the mounted battery (pack). The rechargeable battery (pack) can be mounted in the battery recess in a conventional manner, such as through a spring latch. The battery recess can be closed by a battery cover plate which can be secured to the outer wall of the power assembly in a conventional manner, such as through a screw. The rechargeable battery (pack) can be connected with a charging control circuit, a battery charging temperature detecting circuit and a battery undervoltage monitoring circuit, and the charging control circuit, the battery charging temperature detecting circuit and the battery undervoltage monitoring circuit are further connected to the control system. The battery part, the circuit part and the battery recess are enclosed by a casing to form a modular integrated assembly structure. The various parts can be integrated into different modules by pre-design, integration and assembly, and finally assembled into a whole, and eventually packaged by the casing to form the modular integrated assembly structure.

The power part acquires charging electric energy from the charging base of the autonomous cleaning robot through the second connector. Actually, in addition to using a rechargeable battery, the power part can also be used in combination with a solar battery for example. In addition, if necessary, the power part can include a primary battery and a backup battery, and when the primary battery is low or fails, the backup battery work instead.

In some embodiments, the power part is arranged at the rear end of the vacuum part. When the hand-held dust suction device is in a separated state from the robot body, it is readily understood that the weight of the hand-held dust suction device is mostly from the power part; and when the hand-held dust suction device is held by hand, sometimes the dust suction port needs to downward and towards the surface to be cleaned, and if the tail is too heavy, more force is required to grasp the hand-held dust suction device. Therefore, in some embodiments, the power part can also be arranged on at least one side of the upper side, the lower side, the left side or the right side of the vacuum part, making the power part is close to the geometric center of the hand-held dust suction device, and the center of gravity of the hand-held dust suction device is more forward, thus it more labor-saving to hold the hand-held dust suction device.

In view of the fact that bump or damage is likely to occur during actual use, or dust is liable to enter into the power part and the vacuum part, and considering the noise generated in operation of the vacuum, in some embodiments, the hand-held dust suction device includes a housing at least encapsulating the power part and the vacuum part; on the one hand, the power part and vacuum part disposed therein are protected by the housing, and on the other hand, the noise can be reduced thereby; moreover, the housing can obstruct airflow from escaping from other places than an air vent, the passage of the airflow only includes a vacuum inlet and the air vent, which is more conducive to venting. In some embodiments, the separation and dust collection part is detachably assembled to the housing so as to be removed separately for cleaning or replacement.

In the autonomous cleaning robot in the present application, the autonomous cleaning robot is provided with the hand-held dust suction device, so that the cleaning operation on the ground or other horizontal surface can be performed, and the cleaning operation on the region that is difficult for the existing cleaning robot to reach also can be performed through detaching the hand-held dust suction device from the autonomous cleaning robot body and holding by user. The autonomous cleaning robot of the present application can meet the use requirements in different environments to be cleaned, and has strong practicability, the user does not need to specially purchase different cleaning tools for different environments to be cleaned, thereby greatly saving the cost; moreover, the hand-held dust suction device is assembled on the autonomous cleaning robot body in a tool-free manner, and the disassembly and assembly can be achieved without tools, so the operation is simple and convenient.

In some situations, the user takes no account of the convenience of disassembly and assembly of the dust suction assembly in a tool-free manner, and has more demand on the improved dust suction ability. For example, in venues such as large shopping malls, airports and stadiums, there are very high requirements on the cleaning ability and dust suction ability of the autonomous cleaning device. In this case, a vacuum with higher specifications can be used correspondingly, to meet the requirements on high power, high efficiency, and strong dust suction ability and cleaning ability. In this situation, to increase the space of the dust suction assembly as much as possible, the dust suction assembly can be arranged transversely in the robot body.

During operation of the autonomous cleaning robot, when the autonomous cleaning robot moves, to increase the cleaning coverage area as much as possible and make the first scraper and the second scraper on both sides of the variable dust collection channel as long as possible, so as to collect more rubbish on the ground at each time, the robot body can be configured as a rectangular body with the longitudinal length smaller than the transverse length.

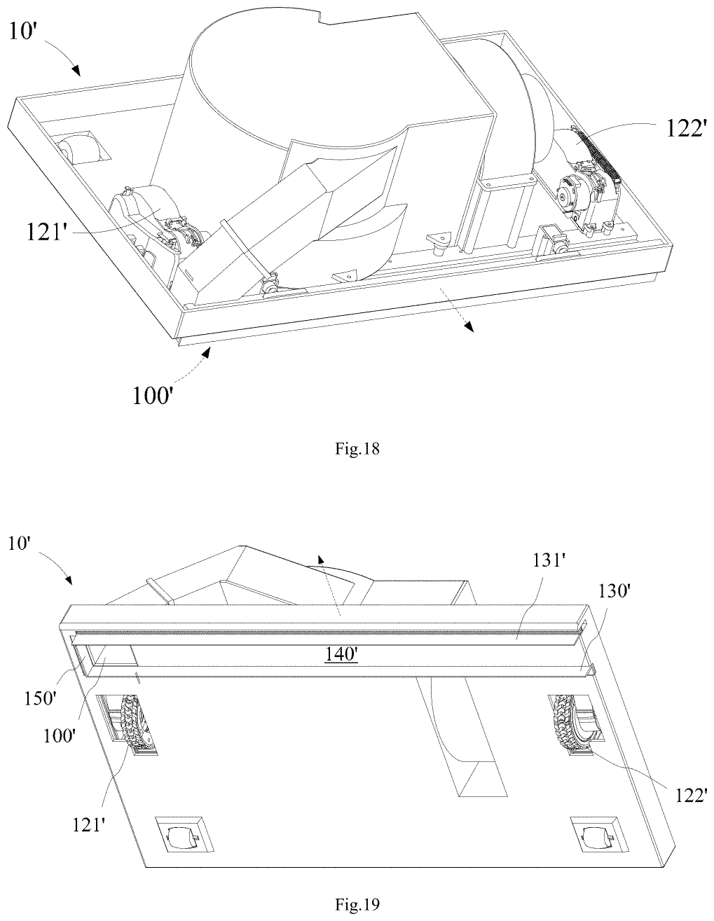

Please refer to FIGS. 18 and 19. FIG. 18 shows a structure diagram at a top view of the autonomous cleaning robot of the present application in an embodiment in the second form, and FIG. 19 shows a structure diagram at a bottom view of the autonomous cleaning robot of the present application in an embodiment in the second form. As shown in FIGS. 18 and 19, the suction port 100′ of the robot body 10′ is close to a first drive wheel 121′ of the drive wheels on both sides of the robot body 10′, and the air vent of the dust suction assembly is close to a second drive wheel 122′ of the drive wheels on both sides of the robot body 10′. The direction in which the drive system drives the robot body 10′ to advance is defined as the longitudinal direction (i.e. the direction indicated by the dotted arrow in FIGS. 18 and 19), and the robot body 10′ is a rectangular body with the longitudinal length smaller than the transverse length.

During operation of the autonomous cleaning robot, in the first state, the second scraper 131′ of the variable dust collection channel 140′ rises or ascends to away from the surface to be cleaned, and the first scraper 130′ collects rubbish into the variable dust collection channel 140′ and obstructs the rubbish from escaping around. When the autonomous cleaning robot switches to the second state, the second scraper 131′ is driven by the drive motor to descend and contact the surface to be cleaned, such that the first scraper 130′, the second scraper 131′ and the suction port 100′ form a dust suction channel, and the vacuum sucks the rubbish in the dust suction channel into the suction port 100′ by means of a suction force. As the dust suction channel has the scraper structures in both front and rear directions for obstruction, thus effectively preventing the rubbish from escaping outward; moreover, as both the first scraper and the second scraper at the front side and the rear side of the dust suction channel contact the surface to be cleaned, air flows from the front direction and the rear direction during movement of the autonomous cleaning robot are obstructed, so that the suction force of the vacuum is greatly enhanced and remarkably increased.

In order to making the dust suction channel more closer to a closed space and thereby making the suction of the vacuum stronger when the autonomous cleaning robot working in the second state, as shown in FIG. 19, a blocking structure 150′ is further provided at one side of the suction port 100′. The blocking structure 150′ is movably arranged at the left side or right side of the suction port 100′, so that in the second state, the first scraper 130′, the second scraper 131′ and the blocking structure 150′ form a dust suction channel with an opening at only one end, in view of this, most air flow can be obstructed, so that the suction force of the vacuum is stronger and the dust suction ability is higher.

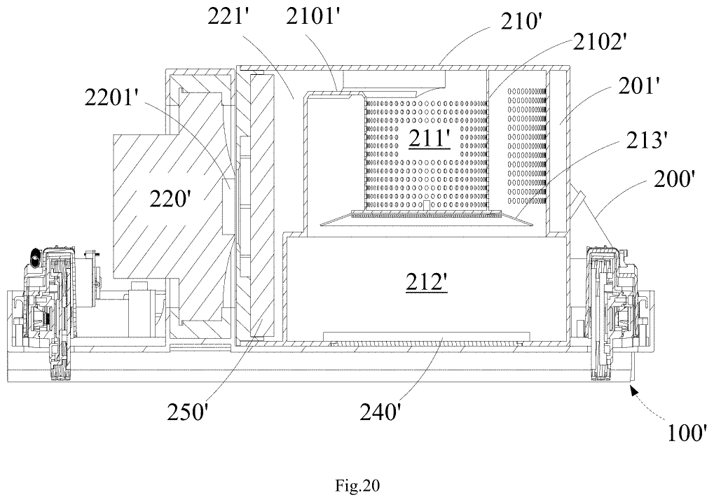

For different application scenarios, the dust suction assembly in the embodiment of the present application and the aforementioned hand-held dust suction device are slightly different in structure. Please refer to FIG. 20, which shows a side sectional view of the autonomous cleaning robot of the present application in an embodiment in the second form. As shown in FIG. 20, the direction of the suction port 100′ is defined as the right direction, and the device, from right to left, are the dust suction head 200′ coupled to the suction port 100′, the separation and dust collection part 210′, the vacuum part and the power part assembled in a modular integrated manner. The power part is used for providing power supply to the vacuum part. In some embodiments, the power part can provide power supply to the control system and the drive system through the electric connection between the first connector and the second connector.

The separation and dust collection part 210′ includes a housing, an air inlet 201′ communicated with the dust suction head 200′, and a chamber, wherein the chamber includes a separation chamber 211′ and a dust collection chamber 212′ communicated with the separation chamber 211′ and disposed on the lower side of the separation chamber 211′. The chamber further includes an outer filter 2101′ and an inner filter 2102′, wherein the outer filter 2101′ is an annular sidewall structure which forms an annular air cavity; or the outer filter 2101′ and a part of the housing together form an annular air cavity. The outer filter 2101′ and the entire housing disposed on the outer side forms an accommodating cavity 221′, or a gap between the outer filter 2101′ and a part of the housing disposed on the outer side forms an accommodating cavity 221′. The inner filter 2102′ is configured as an annular sidewall structure in the annular air cavity, and the middle part of the inner filter 2102′ forms the separation chamber 211′. In some embodiments, a flexible blade 213′ is disposed between the separation chamber 211′ and the dust collection chamber 212′, and a gap is formed between the flexible blade 213′ and the wall of the chamber, so that dust or debris in the separation chamber can fall into the dust collection chamber 212′ through the gap. The material of the flexible blade 213′ is, for example, elastic rubber. When the separated debris in the separation chamber is larger and cannot fall into the dust collection chamber 212′ through the gap, it can bend and deform the flexible blade 213′ by its weight to fall into the dust collection chamber 212′.

When the autonomous cleaning robot moves, dirt such as dust and debris enters into the dust suction port 100′ due to the suction force generated by the vacuum, and then enters into the dust suction head 200′ communicated with the dust suction port 100′, then enters into the separation and dust collection part 210′ through the air inlet 201′, and is separated in the separation and dust collection part 210′. In general, the radial size of dust particles in the dirt is smaller than the radial size of the debris, and the diameter of a first filter hole provided on the outer filter 2101′ is larger than the radial size of the dust particles and smaller than the radial size of the debris; and the diameter of a second filter hole provided on the inner filter 2102′ is smaller than the radial size of the debris. Due to the action of the vacuum part, a large pressure difference is generated between the inside and the outside of the housing of the separation and dust collection part 210′, thus an air stream is formed. The air stream carrying dirt such as dust and debris enters into the chamber from the air inlet 201′, and moves along the inner wall of the annular air cavity to form a cyclone, wherein the radial size of the dust particles in the dirt is smaller than the radial size of the debris, and because the diameter of the first filter hole provided on the outer filter 2101′ is larger than the radial size of the dust particles, and the radial size of the debris is larger than the diameter of the second filter hole provided on the inner filter 2102′, due to a centrifugal force during movement with the cyclone, the light and small dust particles, enters into the accommodating cavity 221′ through the first filter hole to stand, so as to be separated from the debris and no longer disturbed by the air stream. Due to the action of gravity, the debris heavier than the dust drops into the dust collection chamber 212′ through the gap between the flexible blade 213′ and the wall of the chamber, wherein the flexible blade 213′ is used to make the collected debris is in a relatively stable space and not liable to run about, to facilitate cleaning later.

In some embodiments, the bottom of the dust collection chamber 212′ is provided with a cover 240′ that can be opened and closed to facilitate dumping the dirt inside the dust collection chamber 212′ when the dust collection chamber 212′ is full or needs to be cleaned. The cover further includes a fixing structure for fixing the cover to the dust collection chamber. In some embodiments, the cover and the dust collection chamber 212′ can be connected and fixed by a hinge structure and a buckle structure, and the hinge structure can include, for example, a hinge with a simple structure. When it needs to dump the dirt such as dust and debris in the dust collection chamber 212′, the buckle structure is opened, and cover is rotated relative to the bottom of the dust collection chamber 212′ through the hinge, thereby achieving opening and closing of the cover. To clean the dust collection chamber 212′ in time and to prevent the dirt in the dust collection chamber 212′ from overflowing, in some embodiments, the dust suction head 200′ and the separation and dust collection part 210′ are made of a transparent material for more intuitive observation of the collection within the dust collection chamber 212′.

In this case, after filtration or separation by the outer filter 2101′ and the inner filter 2102′, the light and small dust is collected in the accommodation chamber 221′, and the debris is collected in the dust collection chamber 212′, and the air stream originally carrying dirt such as dust and debris becomes a clean air stream, which is discharged from the separation and dust collection part 210′ through the air outlet, and then enters into the vacuum 220′ through the vacuum inlet 2201′.

The vacuum part includes a vacuum inlet 2201′ and a vacuum 220′. In some embodiments, a filter assembly 250′ is disposed on the passage between the separation and dust collection part 210′ and the vacuum part, and a gap is formed between the filter assembly 250′ and the accommodating chamber 221′. The filter assembly 250′ includes a filter element or a similar filter screen structure to further filter the air stream to remove possible residual dust, thereby avoiding that dust in the separation and dust collection part 210′ escapes and damages the vacuum 220′. The filter element or similar filter screen structure is detachable and can be reused, for example, these can be cleaned by brush or water. In some cases, the filter element or similar filter screen structure is a disposable consumable.

The vacuum part further includes an air vent (not shown), which is disposed at the rear end of the vacuum. The air stream enters into the vacuum 220′ through a vacuum inlet 2201′ and is discharged from the dust suction assembly through the air vent. In some embodiments, the air vent can be configured, for example, as a spaced-grid structure, and the gap of grids can be designed according to actual needs, characteristics of the vacuums, the size of the air vent, and the like. The height of the grids can be slightly lower than the height of the passage formed by the air stream passing through the vacuum 220′, such that a flow space is also formed between the grid and the top of the passage. Further, the air vent can also other structures, such as fins or through holes.

As described above, a filter element or a similar filter screen structure is arranged at the air outlet of the separation and dust collection part 210′ to filter air, avoiding that dust in the separation and dust collection part 210′ escapes and damages the vacuum 220′. In order to avoid that the clogging of the filter element or the similar filter screen structure affects the air duct, the cross-sectional area of the air outlet of the separation and dust collection part 210′ is usually large, and the vacuum inlet 2201′ is much smaller than the air outlet of the separation and dust collection part 210′. Therefore, the cross section of the connecting passage communicated the air outlet of the separation and dust collection part 210′ with the vacuum inlet 2201′ is also tapered, so that the air from the filter element or similar filter screen structure of the separation and dust collection part 210′ enters into the vacuum 220′ in a certain direction with as little loss as possible.

In the autonomous cleaning robot of the present application, the variable dust collection channel is provided at the peripheral of the suction port, wherein in a first state, the second scraper of the autonomous cleaning robot rises or ascends to away from a surface to be cleaned, so that the autonomous cleaning robot can collect rubbish on the ground of a large area, and by a blocking effect of the first scraper, it can effectively collect the rubbish such as hair, dust and debris into the variable dust collection channel; and in a second state, the second scraper of the autonomous cleaning robot descends to contact the surface to be cleaned, so that the variable dust collection channel and the communicated suction port form a dust suction channel, and the rubbish is sucked into the suction port by means of the suction force of the vacuum, and then sucked into the dust suction channel. During dust suction, as the first scraper and the second scraper are both in contact with the surface to be cleaned, the rubbish on the ground is not liable to escape to the outside of the variable dust collection channel, thus a strong dust suction ability and high cleaning efficiency can be achieved.

While the above embodiments have been shown and described herein, it will be obvious to those skilled in the art that such embodiments are provided by way of example only, and are not intended to limit the application. Numerous variations, changes, and substitutions will now occur to those skilled in the art without departing from the present application. Therefore, all equivalent modifications or changes made by those skilled in the art without departing from the spirit and scope of the application will be covered by the claims.

1. An autonomous cleaning robot, comprising:
a robot body, comprising an assembly section and a suction port, the suction port being disposed on the bottom of the robot body and towards a surface to be cleaned;
a drive system, comprising drive wheels, the drive wheels being disposed on opposite sides of the robot body and configured to drive the robot body to move;
a control system, disposed on the robot body and configured to control the drive wheels;
a dust suction assembly disposed in the assembly section, an air inlet channel of the dust suction assembly being communicated with the suction port, and the dust suction assembly being used to suck dust under a negative pressure; and
a variable dust collection channel disposed at peripheral side of the suction port, the variable dust collection channel being used for sweeping and scraping to collect dust in a first state and used for forming a dust suction channel communicated with the suction port in a second state;
wherein, the control system is further configured to control switching between the first state and the second state of the variable dust collection channel according to any of the following: a preset time interval, a power output by the dust suction assembly, a traveling distance or speed of the drive wheels.

2. (canceled)

3. The autonomous cleaning robot of claim 1, further comprising a debris detection system configured to detect a debris state, the control system is further configured to control switching between the first state and the second state of the variable dust collection channel according to the detected debris state.

4. The autonomous cleaning robot of claim 1, wherein the variable dust collection channel comprises:
a first scraper, the first scraper is disposed at a first side of the suction port and contacts with the surface to be cleaned, the first scraper is used for sweeping and scraping to collect dust when the robot body moves; and
a second scraper, the second scraper is movably disposed at a second side of the suction port, the first scraper and the second scraper form the dust suction channel communicated with the suction port when the second scraper contacts with the surface to be cleaned.

5. The autonomous cleaning robot of claim 4, wherein a direction in which the drive system drives the robot body to advance is defined as a front direction, the first scraper is disposed at rear side of the suction port, and the second scraper is disposed at front side of the suction port.

6. The autonomous cleaning robot of claim 4, wherein the first scraper and the second scraper are parallel to each other.

7. The autonomous cleaning robot of claim 4, wherein the first scraper or the second scraper is made of a flexible material.

8. The autonomous cleaning robot of claim 4, wherein the length of the dust suction channel formed by the first scraper and the second scraper is equal to or greater than a distance between the drive wheels disposed on either side of the robot body.

9. The autonomous cleaning robot of claim 4, wherein the first scraper or the second scraper comprises a mounting part, a connecting part, a reinforcing part and a blade part, the blade part is used for contacting with the surface to be cleaned.

10. The autonomous cleaning robot of claim 4, wherein the dust suction channel formed by the first scraper and the second scraper is provided with one air inlet arranged on one side of the robot body, and the suction port is disposed at a distal end of the air inlet of the dust suction channel.

11. The autonomous cleaning robot of claim 6, wherein the dust suction channel formed by the first scraper and the second scraper is provided with two air inlets arranged on either side of the robot body, and the suction port is disposed in the middle of the dust suction channel.

12. The autonomous cleaning robot of claim 4 wherein the second scraper is driven by a drive mechanism to go up and down, and the drive mechanism comprises:
a lifting component, comprising a lifting body for assembling the second scraper, the lifting body is provided with a slot;
a swing component, comprising a swing arm and a connecting rod arranged vertically on a first end of the swing arm, the connecting rod is inserted into the slot, and when the swing component swings, the connecting rod performs rectilinear motion relative to the slot and drives the second scraper arranged on the lifting component down to contact with the surface to be cleaned, or up away from the surface to be cleaned; and
a drive motor arranged on the robot body, an output shaft of the drive motor is coupled to a second end of the swing arm perpendicularly, and the drive motor is used to provide swing power to the swing arm.

13. The autonomous cleaning robot of claim 4, wherein the second scraper is driven by a drive mechanism to go up and down, and the drive mechanism comprises:
a rotating component, comprising a rotating body for assembling the second scraper and a rotating shaft provided on the rotating body; and
a drive motor, an output shaft of the drive motor is coupled with a rotating shaft of the rotating component, and the drive motor is used to provide rotary power to the rotating shaft to drive the second scraper arranged on the rotating body to contact with the surface to be cleaned, or up away from the surface to be cleaned.

14. The autonomous cleaning robot of claim 1, wherein the robot body is provided with at least one driven wheel, the driven wheel together with the drive wheels on both sides of the robot body keep the balance of the robot body in a moving state.

15. The autonomous cleaning robot of claim 1, wherein the robot body is provided with a cliff sensor on at least one side.

16. The autonomous cleaning robot of claim 1, wherein a direction in which the drive system drives the robot body to advance is defined as a front direction, and a bumper assembly is provided at front end of the robot body.

17. The autonomous cleaning robot of claim 1, wherein a direction in which the drive system drives the robot body to advance is defined as a front direction, and a plurality of obstacle detectors are arranged at periphery of front end of the robot body.

18. The autonomous cleaning robot of claim 1, wherein the control system comprises at least one system of a positioning and navigation system, a mileage calculation system, a vision measurement system, an object recognition system, and a voice recognition system.

19. The autonomous cleaning robot of claim 1, wherein a direction in which the drive system drives the robot body to advance is defined as a longitudinal direction, and the dust suction assembly is arranged in the robot body in a transverse direction, wherein, the longitudinal direction is perpendicular to the transverse direction.

20. The autonomous cleaning robot of claim 19, wherein the suction port of the robot body is adjacent to a first drive wheel of the drive wheels on either side of the robot body, and an air outlet of the dust suction assembly is adjacent to a second drive wheel of the drive wheels on either side of the robot body.
